(19) United States
(12) Patent Application Publication
(10) Pub. No.: US 2022/0021899 A1
(43) Pub. Date: Jan. 20, 2022

(54) IMAGE ENCODING APPARATUS, IMAGE ENCODING METHOD, IMAGE DECODING APPARATUS, AND IMAGE DECODING METHOD

(71) Applicant: SONY GROUP CORPORATION, TOKYO (JP)

(72) Inventor: KENJI KONDO, TOKYO (JP)

(21) Appl. No.: 17/311,800

(22) PCT Filed: Dec. 4, 2019
(86) PCT No.: PCT/JP2019/047342

§ 371 Date: Jun. 8, 2021

(30) Foreign Application Priority Data
Dec. 17, 2018 (JP) 2018-235107

(51) Int. Cl. H04N 19/52; H04N 19/176; H04N 19/139; H04N 19/577

(52) U.S. Cl. CPC H04N 19/52; H04N 19/577; H04N 19/139; H04N 19/176

(57) ABSTRACT

The present disclosure relates to an image encoding apparatus, an image encoding method, an image decoding apparatus, and an image decoding method that make it possible to suppress image quality deterioration while reducing a processing amount of an inter-prediction process using subblocks.

Subblock size identification information identifying a size or a shape of subblocks used for an inter-prediction process on an image is set on a basis of a motion vector used for motion compensation in an affine transformation, the image is encoded by performing the inter-prediction process of applying the affine transformation on the subblocks with the size or the shape according to the setting, and a bitstream including the subblock size identification information is generated. The present technology can be applied to an encoding apparatus that encodes images, and a decoding apparatus that decodes images, for example.

### TECHNICAL FIELD

The present disclosure relates to an image encoding apparatus, an image encoding method, an image decoding apparatus, and an image decoding method, and in particular relates to an image encoding apparatus, an image encoding method, an image decoding apparatus, and an image decoding method that make it possible to suppress image quality deterioration while reducing a processing amount of an inter-prediction process used for subblocks.

### BACKGROUND ART

In ITU-T (International Telecommunication Union Telecommunication Standardization Sector), the JVET (Joint Video Exploration Team), which is carrying out the development of next generation video encoding, has proposed diverse video coding as disclosed in NPL 1.

For example, the JVET has proposed an inter-prediction process (Affine motion compensation (MC) prediction) for performing motion compensation by performing an affine transformation on a reference image on the basis of motion vectors of the vertices of subblocks. According to the inter-prediction process, it is possible to predict not only translation (parallel movement) between screens, but also rotation, scaling (expansion/contraction), more complicated movements referred to as skew, and the like, and it is expected that the encoding efficiency improves along with an improvement of the prediction quality.

### CITATION LIST

### Non Patent Literature

### [NPL 1]

Benjamin Bross, Jianle Chen, Shan Liu, “Versatile Video Coding (Draft 2)”, Document: JVET-K1001-v7, Joint Video Experts Team (JVET) of ITU-T SG 16 WP 3 and ISO/IEC JTC 1/SC 29/WG 1111th Meeting: Ljubljana, SI, 10-18 Jul. 2018

### SUMMARY

### Technical Problem

Meanwhile, in an inter-prediction process that uses subblocks like the one mentioned above, the process is performed on a larger number of subblocks along with a decrease in the size of the subblocks, and this results in an increase of a processing amount when encoding or decoding is executed. In contrast to this, in a case that it is attempted to reduce the processing amount of an inter-prediction process, there is a concern over deterioration of the image quality.

The present disclosure has been made in view of such a situation, and is to make it possible to suppress image quality deterioration while reducing the processing amount of an inter-prediction process using subblocks.

### Solution to Problem

An image encoding apparatus according to a first aspect of the present disclosure includes a setting section that sets identification information identifying a size or a shape of subblocks used for an inter-prediction process on an image, on the basis of a motion vector used for motion compensation in an affine transformation, and an encoding section that encodes the image by performing the inter-prediction process of applying the affine transformation on the subblocks with the size or the shape according to the setting by the setting section, and generates a bitstream including the identification information.

An image encoding method according to the first aspect of the present disclosure includes setting, by an image encoding apparatus that encodes an image, identification information identifying a size or a shape of subblocks used for an inter-prediction process on the image, on the basis of a motion vector used for motion compensation in an affine transformation, and encoding, by the image encoding apparatus, the image by performing the inter-prediction process of applying the affine transformation on the subblocks with the size or the shape according to the setting, and generating a bitstream including the identification information.

In the first aspect of the present disclosure, identification information identifying a size or a shape of subblocks used for an inter-prediction process on the image is set on the basis of a motion vector used for motion compensation in an affine transformation, the image is encoded by performing the inter-prediction process of applying the affine transformation on the subblocks with the size or the shape according to the setting, and a bitstream including the identification information is generated.

An image encoding apparatus according to a second aspect of the present disclosure includes a parsing section that parses a bitstream including identification information to obtain the identification information, the identification information being set on the basis of a motion vector used for motion compensation in an affine transformation, and identifying a size or a shape of subblocks used for an inter-prediction process on an image, and a decoding section that decodes the bitstream by performing the inter-prediction process of applying the affine transformation on the subblocks with the size or the shape according to the identification information obtained by the parsing by the parsing section, and generates the image.

An image decoding method according to the second aspect of the present disclosure is an image decoding method including parsing, by an image decoding apparatus that decodes an image, a bitstream including identification information to obtain the identification information, the identification information being set on the basis of a motion vector used for motion compensation in an affine transformation, and identifying a size or a shape of subblocks used for an inter-prediction process on the image, and decoding, by the image decoding apparatus, the bitstream by performing the inter-prediction process of applying an affine transformation on the subblocks with the size or the shape according to the identification information obtained by the parsing, and generating the image.

In the second aspect of the present disclosure, a bitstream including identification information is parsed to obtain the identification information, the identification information being set on the basis of a motion vector used for motion compensation in an affine transformation, and identifying a size or a shape of subblocks used for an inter-prediction process on the image, the bitstream is decoded by performing the inter-prediction process of applying an affine transformation on the subblocks with the size or the shape according to the identification information obtained by the parsing, and the image is generated.

### BRIEF DESCRIPTION OF DRAWINGS

FIG. 1 is a block diagram depicting a configuration example of one embodiment of an image processing system to which the present technology is applied.

FIG. 2 is a figure for explaining a process performed in an encoding circuit.

FIG. 3 is a figure for explaining a process performed in a decoding circuit.

FIG. 4 is a figure for explaining an affine transformation accompanying a rotation operation.

FIG. 5 is a figure for explaining an interpolation filtering process.

FIG. 6 is a figure for explaining the numbers of pixel values that are necessary for 4×4 subblocks, and 8×4 subblocks.

FIG. 7 is a figure depicting how it appears when a Type-1 affine transformation in which the shape of subblocks is 8×4 is performed.

FIG. 8 is a figure depicting how it appears when a Type-2 affine transformation in which the shape of subblocks is 4×8 is performed.

FIG. 9 is a figure for explaining an example in which subblocks with Type-1 shape are used for L0 prediction, and subblocks with Type-2 shape are used for L1 prediction.

FIG. 10 is a figure for explaining an example in which subblocks with Type-2 shape are used for L0 prediction, and subblocks with Type-1 shape are used for L1 prediction.

FIG. 11 is a figure for explaining how different types, Type 1 and Type 2, are applied on a case-by-case basis to L0 prediction and L1 prediction.

FIG. 12 is a block diagram depicting a configuration example of one embodiment of an image encoding apparatus.

FIG. 13 is a block diagram depicting a configuration example of one embodiment of an image decoding apparatus.

FIG. 14 is a flowchart for explaining an image encoding process.

FIG. 15 is a flowchart for explaining a first processing example of a process of setting subblock size identification information.

FIG. 16 is a flowchart for explaining a second processing example of the process of setting the subblock size identification information.

FIG. 17 is a flowchart for explaining a third processing example of the process of setting the subblock size identification information.

FIG. 18 is a flowchart for explaining a fourth processing example of the process of setting the subblock size identification information.

FIG. 19 is a flowchart for explaining an image decoding process.

FIG. 20 is a block diagram depicting a configuration example of one embodiment of a computer to which the present technology is applied.

### DESCRIPTION OF EMBODIMENTS

<Documents, etc. Supporting Technical Contents and Technical Terms>

The scope of disclosure of the present technology covers not only contents described in embodiments, but also contents described in the following Non-Patent Documents that are known at the time of the application.
NPL 1: Jianle Chen, Elena Alshina, Gary J. Sullivan, Jens-Rainer, JillBoyce, “Algorithm Description of Joint Exploration Test Model 4”, JVET-G1001_v1, Joint Video Exploration Team (JVET) of ITU-T SG 16 WP 3 and ISO/IEC JTC 1/SC 29/WG 11 7th Meeting: Torino, IT, 13-21 Jul. 2017
NPL 2: TELECOMMUNICATION STANDARDIZATION SECTOR OF ITU (International Telecommunication Union), “High efficiency video coding”, H.265, December 2016
NPL 3: TELECOMMUNICATION STANDARDIZATION SECTOR OF ITU (International Telecommunication Union), “Advanced video coding for generic audiovisual services”, H.264, April 2017

That is, the contents described in Non-Patent Documents 1 to 3 mentioned above also become grounds for making a decision as to whether or not the support requirement is satisfied. For example, even in a case that, in embodiments, there are no direct descriptions of QTBT (Quad Tree Plus Binary Tree) Block Structure described in Non-Patent Document 1, or QT (Quad-Tree Block Structure) described in Non-Patent Document 2, they are included in the scope of disclosure of the present technology, and the support requirement of claims is deemed to be satisfied. In addition, the same applies to technical terms such as parsing, syntax, or semantics, for example, and even in a case that there are no direct descriptions about them in embodiments, they are included in the scope of disclosure of the present technology, and the support requirement of claims is deemed to be satisfied.

<Terms>

In the present application, the following terms are defined as follows.

<Blocks>

Unless noted otherwise, “blocks” (not blocks representing processing sections) used for explanations of partial areas and processing units of an image (picture) represent certain partial areas in the picture, and the size, shape, characteristics and the like of those partial areas are not limited. For example, “blocks” include certain partial areas (processing units) such as TB (Transform Block), TU (Transform Unit), PB (Prediction Block), PU (Prediction Unit), SCU (Smallest Coding Unit), CU (Coding Unit), LCU (Largest Coding Unit), CTB (Coding TreeBlock), CTU (Coding Tree Unit), transformation block, subblock, macroblock, tile, or slice.

<Specification of Block Size>

In addition, when the size of such blocks is specified, the block size may not only be specified directly, but may also be specified indirectly. For example, the block size may be specified by using identification information identifying the size. In addition, for example, the block size may be specified by using a ratio to or a difference from the size of a reference block (e.g. an LCU, an SCU, etc.). For example, in a case that information specifying the block size is transferred as a syntax element or the like, as the information, information indirectly specifying the size like the ones mentioned above may be used. In such a way, an information amount of the information can be reduced, and the encoding efficiency can be enhanced, in some cases. In addition, the specification of the block size also includes specification of a range of block sizes (e.g. specification of a range of tolerated block sizes, etc.).

<Units of Information and Processes>

Data units for which various types of information are set, and data units that are the targets of various types of process can be any data units, and are not limited to examples mentioned above. For example, the information may each be set for each TU (Transform Unit), TB (Transform Block), PU (Prediction Unit), PB (Prediction Block), CU (Coding Unit), LCU (Largest Coding Unit), subblock, block, tile, slice, picture, sequence or component, and data of these data units may be targets of the processes. Certainly, a data unit can be set for each piece of information or each process, and data units of all the information and processes need not be set uniformly. Note that storage locations of these pieces of information can be any locations, and may be stored in headers, parameter sets or the like of data units mentioned above. In addition, they may be stored in a plurality of locations.

<Control Information>

Control information regarding the present technology may be transferred from the encoding side to the decoding side. For example, control information (e.g. enabled_flag) for controlling whether to or not to permit (or prohibit) application of the present technology mentioned above may be transferred. In addition, for example, control information representing a target to which the present technology mentioned above is applied (or a target to which the present technology is not applied) may be transferred. For example, control information specifying a block size (the upper limit or the lower limit, or both), a frame, a component, a layer or the like to which the present technology is applied (or specifying whether it is permitted or prohibited to apply the present technology to it) may be transferred.

<Flags>

Note that “flags” in the present specification are information for identifying a plurality of states, and include not only information used at the time when two states, true (1) and false (0), are identified, but also information that allows identification of three states or more. Accordingly, values that the “flags” can have may be two values, I/O, for example, and may be three values or more. That is, the number of bits included in a “flag” can be any number, and the flags may be represented by one bit or may be represented by multiple bits. In addition, supposed forms of identification information (including flags also) include not only one in which identification information is included in a bitstream, but also one in which differential information of identification information relative to certain reference information is included in a bitstream. Accordingly, in the present specification, “flags” and “identification information” incorporate not only the information, but also differential information relative to reference information.

<Associating Metadata>

In addition, various types of information (metadata, etc.) related to encoded data (bitstream) may be transferred or recorded in any form as long as the various types of information are associated with the encoded data. Here, regarding the meaning of the term “associate,” when one piece of data and another piece of data are associated with each other, for example, the one piece of data becomes available at the time when another piece of data is processed (the one piece of data can be linked with the other piece of data). That is, mutually associated pieces of data may be combined into one piece of data, or may be separate pieces of data. For example, information associated with encoded data (image) may be transferred on a transfer path which is different from a transfer path on which the encoded data (image) is transferred. In addition, for example, information associated with encoded data (image) may be recorded on a recording medium different from a recording medium on which the encoded data (image) is recorded (or in another recording area of the same recording medium on which the encoded data (image) is recorded). Note that this “association” may be performed not on the entire data but may be performed on part of the data. For example, an image, and information corresponding to the image may be associated with each other in a certain unit such as a plurality of frames, one frame, or part of a frame.

Note that, in the present specification, terms such as “synthesize,” “multiplex,” “add,” “integrate,” “include,” “store,” “push in,” “put in” or “insert” mean that a plurality of objects is combined into one, like combining encoded data and metadata into one piece of data, for example, and mean one method of “association” mentioned above. In addition, in the present specification, encoding includes not only the entire process of transforming an image into a bitstream, but also a partial process. For example, encoding includes not only a process incorporating a prediction process, an orthogonal transformation, quantization, arithmetic encoding and the like, but also a process by which quantization and arithmetic encoding are collectively referred to, a process incorporating a prediction process, quantization, and arithmetic encoding, and the like. Similarly, decoding includes not only the entire process of transforming a bitstream into an image, but also a partial process. For example, decoding includes not only a process incorporating inverse arithmetic decoding, inverse quantization, an inverse orthogonal transformation, a prediction process and the like, but also a process incorporating inverse arithmetic decoding and inverse quantization, a process incorporating inverse arithmetic decoding, inverse quantization, and a prediction process, and the like.

In the following, specific embodiments to which the present technology is applied are explained in detail with reference to the figures.

<Overview of Present Technology>

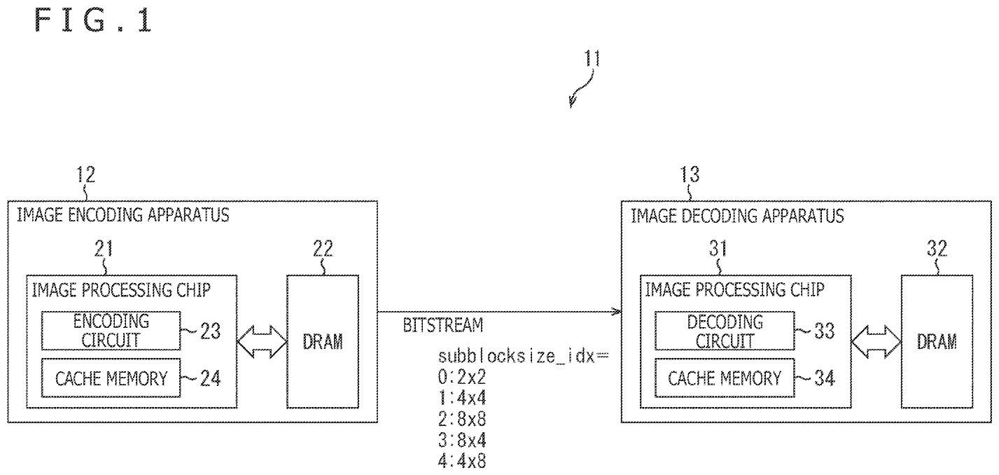

The overview of the present technology is explained with reference to FIG. 1 to FIG. 11.

FIG. 1 is a block diagram depicting a configuration example of one embodiment of an image processing system to which the present technology is applied.

As depicted in FIG. 1, an image processing system 11 includes an image encoding apparatus 12 and an image decoding apparatus 13. For example, in the image processing system 11, an image captured by an image-capturing apparatus which is not depicted is input to the image encoding apparatus 12, and the image encoding apparatus 12 encodes the image to generate encoded data. Thereby, in the image processing system 11, the encoded data is transferred from the image encoding apparatus 12 to the image decoding apparatus 13 as a bitstream. Then, in the image processing system 11, the image decoding apparatus 13 decodes the encoded data to generate an image, and the image is displayed on a display apparatus which is not depicted.

The image encoding apparatus 12 has a configuration in which an image processing chip 21 and an external memory 22 are connected via a bus.

The image processing chip 21 includes an encoding circuit 23 that encodes an image, and a cache memory 24 that temporarily stores data that becomes necessary when the encoding circuit 23 encodes the image.

The external memory 22 includes a DRAM (Dynamic Random Access Memory), for example, and stores, for each processing unit (e.g. frame) processed at the image processing chip 21, data of an image which is a target of encoding at the image encoding apparatus 12. Note that in a case that QTBT (Quad Tree Plus Binary Tree) Block Structure described in NPL 1 or QT (Quad-Tree) Block Structure described in NPL 2 is applied as Block Structure, CTB (Coding TreeBlock), CTU (Coding Tree Unit), PB (Prediction Block), PU (Prediction Unit), CU (Coding Unit), or CB (Coding Block) is used as the processing unit for the storage on the external memory 22, in some cases. It is expected that suitably CTB or CTU, which is a processing unit in which the block size is fixed for each sequence, is used as the processing unit.

For example, in the image encoding apparatus 12, data which is obtained by dividing data of an image for one frame (or CTB) stored on the external memory 22, and each of which corresponds to a subblock which is the processing unit used for an inter-prediction process is read into the cache memory 24. Then, in the image encoding apparatus 12, encoding by the encoding circuit 23 is performed for each subblock stored on the cache memory 24, and encoded data is generated.

Here, the size of subblocks (the total number of pixels), and the shape of the subblocks (the number of pixels in the height direction×the number of pixels in the width direction) are identified on the basis of subblock size identification information. Then, in the image processing system 11, the encoding circuit 23 sets the subblock size identification information, and a bitstream including the subblock size identification information is transferred from the image encoding apparatus 12 to the image decoding apparatus 13.

For example, in a case that a subblock includes 2×2 pixels, the subblock size identification information is set to 0. Similarly, in a case that a subblock includes 4×4 pixels, the subblock size identification information is set to 1, and in a case that the size of subblocks is 8×8, the subblock size identification information is set to 2.

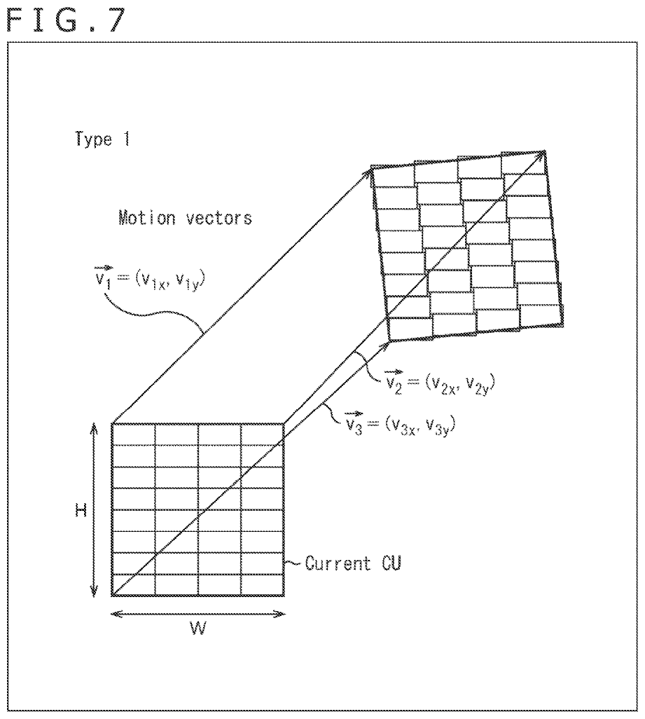

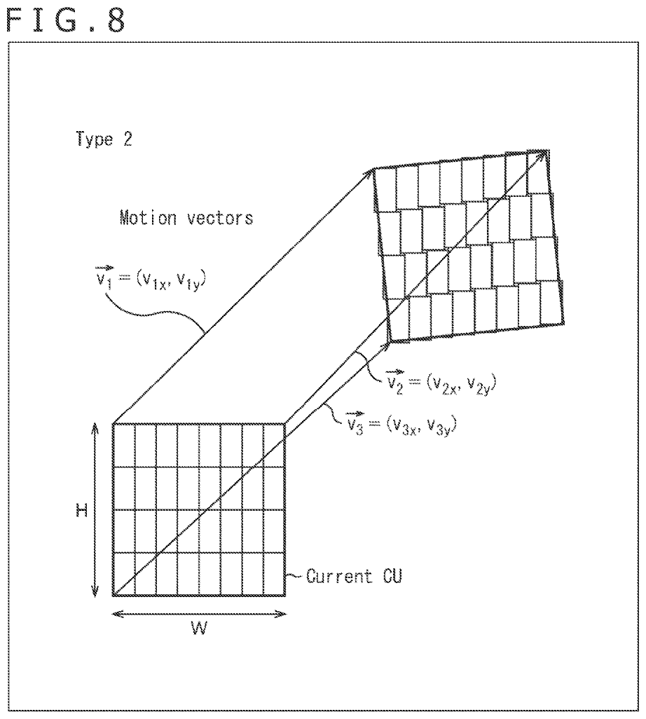

Furthermore, in a case that a subblock includes 8×4 pixels (Type 1 in FIG. 7 mentioned below), the subblock size identification information is set to 3, and in a case that the size of subblocks is 4×8 (Type 2 in FIG. 8 mentioned below), the subblock size identification information is set to 4. Other than these, subblocks with the size and the shape equal to or larger than 16×16 may be used. In summary, the subblock size identification information can be expressed in any form as long as the subblock size identification information is information that enables identification of the size and the shape of subblocks. Note that the subblock size identification information may identify only one of the size and the shape of subblocks.

The image decoding apparatus 13 has a configuration in which an image processing chip 31 and an external memory 32 are connected via a bus.

The image processing chip 31 includes a decoding circuit 33 that decodes encoded data, and generates an image, and a cache memory 34 that temporarily stores data that becomes necessary when the decoding circuit 33 decodes the encoded data.

The external memory 32 includes a DRAM, for example, and stores, for each frame of an image, the encoded data which is a target of decoding at the image decoding apparatus 13.

For example, in the image decoding apparatus 13, the subblock size identification information is obtained by parsing a bitstream, and the encoded data is read out from the external memory 32 to the cache memory 34 in accordance with subblocks with the size and the shape set in the subblock size identification information. Then, at the image decoding apparatus 13, the encoded data is decoded by the decoding circuit 33 for each block stored on the cache memory 34 to thereby generate an image.

In this manner, in the image processing system 11, the image encoding apparatus 12 sets the subblock size identification information for identifying the size and the shape of subblocks, and a bitstream including the subblock size identification information is transferred to the image decoding apparatus 13. For example, in the image processing system 11, the subblock size identification information (subblocksize_idx) can be defined by using high level syntax such as an SPS, a PPS, or a SLICE header. In addition, in terms of the relation with predictions, and performance enhancement, the subblock size identification information is preferably defined in a SLICE header, and in terms of the simplification of processes, and parsing at the image decoding apparatus 13, the subblock size identification information is preferably defined in an SPS or a PPS.

Then, in the image processing system 11, for example, the number of subblocks per processing unit (e.g. per frame, per CTB, etc.) can be reduced by using subblocks with a larger size. As a result, the processing amount of an inter-prediction process performed for each subblock can be reduced. Accordingly, for example, in an application that requires the suppression of a processing amount, encoding or decoding can be performed more surely by performing an inter-prediction process by using larger subblocks.

In addition, there is a concern about the image processing system 11 that the image quality deteriorates in a case that the processing amount is reduced by using larger subblocks. In view of this, in the image processing system 11, image quality deterioration can be suppressed by using 8×4 subblocks or 4×8 subblocks, instead of 8×8 subblocks, in accordance with the processing capability, for example.

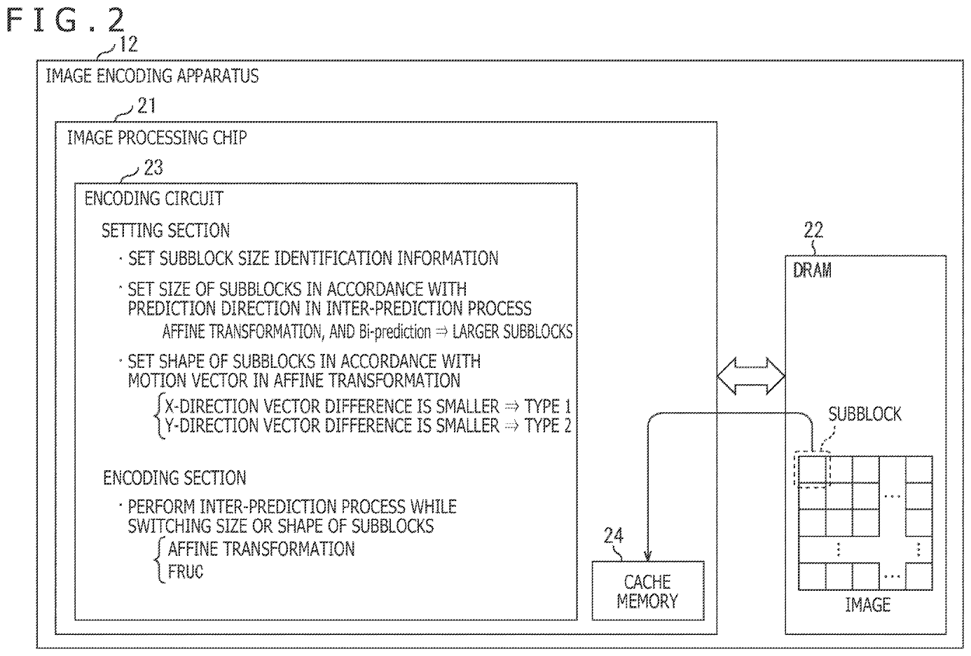

Processes performed by the encoding circuit 23 of the image encoding apparatus 12 are explained further with reference to FIG. 2.

For example, the encoding circuit 23 is designed to function as a setting section and an encoding section like the ones depicted in the figure.

That is, the encoding circuit 23 can perform a setting process of setting the subblock size identification information for identifying the size and the shape (e.g. 2×2, 4×4, 8×8, 4×8, 8×4, etc.) of subblocks used for an inter-prediction process when an image is encoded.

At this time, for example, the encoding circuit 23 sets the subblock size identification information such that the size of subblocks is larger in a case that the processing amount required in an application that executes the encoding of an image in the image encoding apparatus 12 is equal to or smaller than a predetermined setting value. Similarly, for example, the encoding circuit 23 sets the subblock size identification information such that the size of subblocks is larger in a case that the processing amount required at an application that executes the decoding of a bitstream in the image decoding apparatus 13 is equal to or smaller than a predetermined setting value. Here, setting values that define the processing amounts in the applications to be executed by the image encoding apparatus 12 and the image decoding apparatus 13 are preset in accordance with the processing capabilities that the image encoding apparatus 12 and the image decoding apparatus 13 have. For example, in a case that the encoding process or the decoding process is performed in a mobile terminal having a low processing capability, a low setting value according to the processing capability is set.

Furthermore, the encoding circuit 23 can set the size of subblocks in accordance with the prediction direction in an inter-prediction process. For example, the encoding circuit 23 sets the subblock size identification information such that the size of subblocks differs in accordance with whether or not the prediction direction in an inter-prediction process is Bi-prediction. In addition, the encoding circuit 23 sets the subblock size identification information such that the size of subblocks becomes larger in a case that the prediction direction in an inter-prediction process is Bi-prediction. Alternatively, the encoding circuit 23 sets the subblock size identification information such that the size of subblocks becomes larger in a case that an affine transformation is applied as an inter-prediction process, and the prediction direction in the inter-prediction process is Bi-prediction.

In addition, in a case that an affine transformation is applied as an inter-prediction process, the encoding circuit 23 can set the shape of subblocks in accordance with motion vectors in the affine transformation. For example, in a case that an X-direction vector difference determined in accordance with Formula (1) mentioned below from motion vectors in the affine transformation is smaller than a Y-direction vector difference, the encoding circuit 23 sets the subblock size identification information such that it represents the shape of Type 1 (see FIG. 7) in which the longitudinal direction of rectangular subblocks coincides with an X direction. On the other hand, in a case that the Y-direction vector difference determined in accordance with Formula (1) mentioned below from motion vectors in the affine transformation is smaller than the X-direction vector difference, the encoding circuit 23 sets the subblock size identification information such that it represents the shape of Type 2 (see FIG. 8) in which the longitudinal direction of rectangular subblocks coincides with a Y direction.

Then, the encoding circuit 23 can perform an encoding process of encoding images by performing an inter-prediction process while switching the size or the shape of subblocks, and generating a bitstream including the subblock size identification information.

At this time, the encoding circuit 23 applies an affine transformation or an FRUC (Frame Rate Up Conversion) to subblocks to perform an inter-prediction process. Other than them, the encoding circuit 23 may apply translation or the like to perform an inter-prediction process. Note that the encoding circuit 23 may switch the size or the shape of subblocks by referring to the subblock size identification information, or may switch the size or the shape of subblocks by making a decision like the one mentioned above according to a prediction direction or the like, when an inter-prediction process is performed.

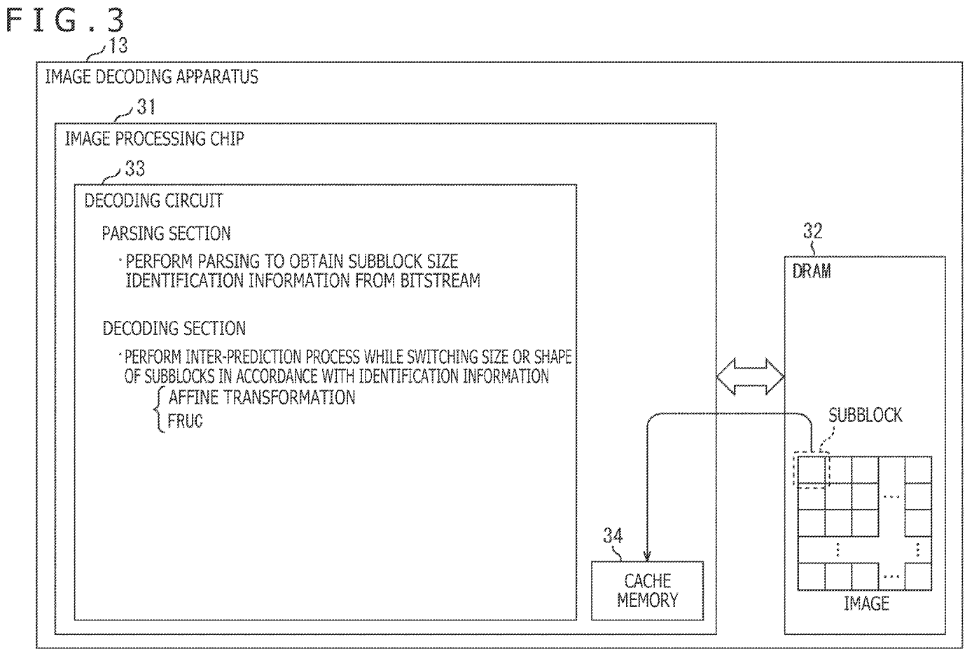

Processes performed by the decoding circuit 33 of the image decoding apparatus 13 are explained further with reference to FIG. 3.

For example, the decoding circuit 33 is designed to function as a parsing section and a decoding section like the ones depicted in the figure.

That is, the decoding circuit 33 can perform a parsing process of parsing a bitstream transferred from the image encoding apparatus 12 to obtain the subblock size identification information representing the size of subblocks used for an inter-prediction process when an image is decoded.

Then, the decoding circuit 33 can perform a decoding process of performing an inter-prediction process while switching the size or the shape of subblocks in accordance with the subblock size identification information, decoding the bitstream, and generating images. At this time, the decoding circuit 33 performs an inter-prediction process in accordance with the affine transformation or FRUC that is applied at the inter-prediction process in the encoding circuit 23.

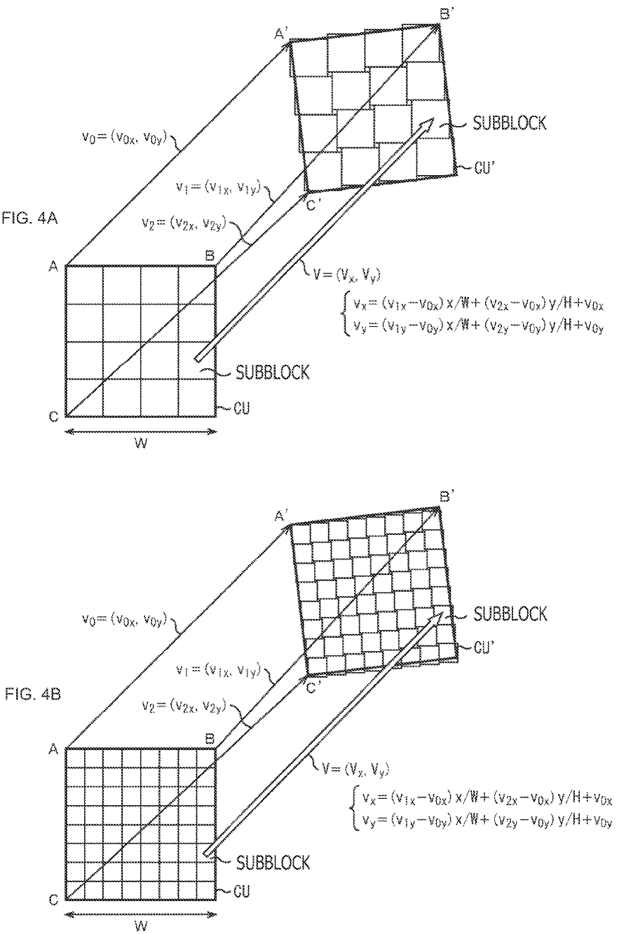

Here, affine transformations that accompany rotation operations in coding units divided into subblocks with different sizes are explained with reference to FIG. 4.

A in FIG. 4 depicts one example in which an affine transformation accompanying a rotation operation in a coding unit divided into 4×4, 16 subblocks is performed. In addition, B in FIG. 4 depicts one example in which an affine transformation accompanying a rotation operation in a coding unit divided into 8×8, 64 subblocks is performed.

For example, in motion compensation of an affine transformation, a coding unit CU′ having a point A′ that is apart from a vertex A in a reference image by a motion vector v₀ as an upper left vertex, a point B′ that is apart from a vertex B in the reference image by a motion vector v₁ as an upper right vertex, and a point C′ that is apart from a vertex C in the reference image by a motion vector v2 as a lower left vertex is defined as a reference block. An affine transformation is performed on the coding unit CU′ on the basis of the motion vector v₀ or v₂ to thereby perform motion compensation, and generate a prediction image of the coding unit CU.

That is, the processing-target coding unit CU is divided into subblocks, and the motion vector v=(vₓ, v_{y}) of each subblock is determined in accordance with depicted formulae on the basis of the motion vectors v₀=(v₀ₓ, v_{0y}), v₁=(v₁ₓ, v_{1y}), and v₂=(v₂ₓ, v_{2y}).

Then, by translating each reference subblock that is in the reference image, and has the size identical to a subblock apart from the subblock by a motion vector v on the basis of the motion vector v, a prediction image of the coding unit CU is generated for each subblock.

Here, in a case that such an affine transformation accompanying a rotation operation is performed, a prediction image with higher prediction precision can be obtained by dividing a coding unit into subblocks with a smaller size as depicted in B in FIG. 4, than by dividing a coding unit into subblocks with a larger size as depicted in A in FIG. 4. However, dividing a coding unit into subblocks with a smaller size not only makes it necessary to perform more calculations as the number of subblocks increases, to increase the processing amount, but also increases the length of time for reading out data from a memory, to hinder an increase of processing speed inevitably.

Accordingly, in particular, by setting the size of subblocks large in such an affine transformation, it is possible to reduce the processing amount more effectively, and also it is possible to attempt to increase the processing speed. Note that although a CU and a PU are explained here as being processed as blocks in the same dimensions, in a case that a CU and a PU can be configured as blocks in different dimensions as in QT, a block may be divided into subblocks using the PU as a reference block.

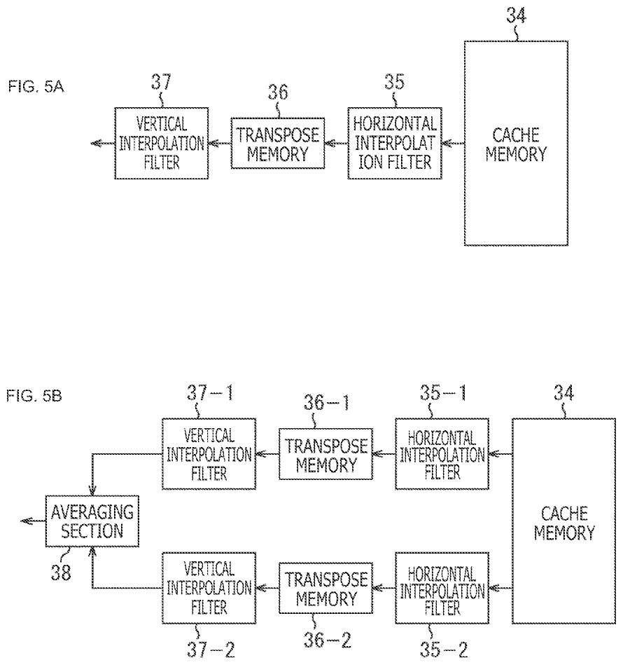

Here, an interpolation filtering process is explained with reference to FIG. 5. Note that although the decoding process by the image decoding apparatus 13 is explained here, an interpolation filtering process is performed similarly in the encoding process by the image encoding apparatus 12.

For example, when the image decoding apparatus 13 performs motion compensation in an affine transformation when decoding an image, for example, encoded data that is in a decoding frame (or referred to as a Decoded picture buffer) having been encoded stored on the external memory 32, and is necessary for the motion compensation is read into the cache memory 34 inside the image processing chip 31. Then, in the decoding circuit 33, an interpolation filtering process with a configuration like the one depicted in FIG. 5 is performed.

A in FIG. 5 depicts a filter processing section that performs an interpolation filtering process when the prediction direction is Uni-prediction, and B in FIG. 5 depicts a filter processing section that performs an interpolation filtering process when the prediction direction is Bi-prediction.

For example, as depicted in A in FIG. 5, in Uni-prediction, a horizontal interpolation filtering process is performed at a horizontal interpolation filter 35 on encoded data (pixel values) for subblocks read out from the cache memory 34. Then, after the encoded data is stored on a transpose memory 36 for taking out encoded data in the vertical direction, a vertical interpolation filtering process is performed at a vertical interpolation filter 37 on the encoded data read out from the transpose memory 36, and the encoded data is output to downstream processing sections.

In addition, in Bi-prediction, as depicted in B in FIG. 5, an L0 reference interpolation filtering process by a horizontal interpolation filter 35-1, a transpose memory 36-1, and a vertical interpolation filter 37-1, and an L1 reference interpolation filtering process by a horizontal interpolation filter 35-2, a transpose memory 36-2, and a vertical interpolation filter 37-2 are performed in parallel. Then, the average of an output from the vertical interpolation filter 37-1, and an output from the vertical interpolation filter 37-2 is determined at an averaging section 38, and then is output to downstream processing sections.

When such interpolation filtering processes on subblocks are performed, reading of the encoded data from the cache memory 34 to the horizontal interpolation filter 35, and reading of the encoded data from the transpose memory 36 to the vertical interpolation filter 37 are restricted due to the bands of the memories. Thereby, an increase of speed is hindered. In particular, in a case that the prediction direction in an inter-prediction process is Bi-prediction, the band of a memory which is twice as large is necessary, and it becomes more likely to be subject to the restriction due to the band of the memory.

In view of this, when performing an interpolation filtering process, the decoding circuit 33 is required to avoid the restriction caused by the band of the memory, and reduce the processing amount in the decoding process.

In view of this, for example, while an interpolation filtering process has conventionally been performed for 4×4 subblocks, by performing an interpolation filtering process for 8×4 or 4×8 subblocks which are larger than 4×4 subblocks, it is possible to attempt to reduce the processing amount, and also to reduce the number of pixel values necessary for an interpolation filtering process.

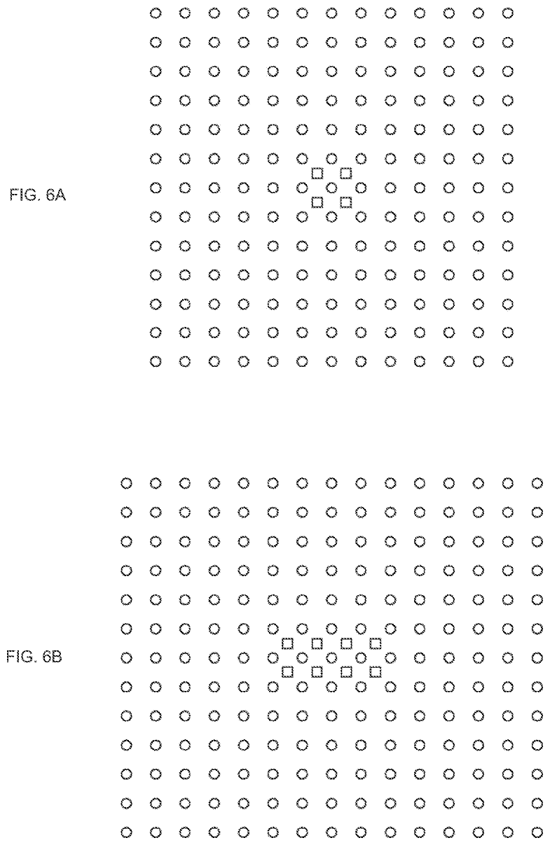

For example, in a case that an interpolation filtering process of determining four pixel values for 2×2 subblocks is performed as depicted in A in FIG. 6, 13×13 pixel values are necessary. In addition, in a case that an interpolation filtering process of determining eight pixel values for 4×2 subblocks is performed as depicted in B in FIG. 6, 13×15 pixel values are necessary. Because of this, when an interpolation filtering process using 2×2 subblocks is performed twice to determine eight pixel values, the number of pixel values which is twice as large as 13×13 becomes necessary inevitably, and the number of necessary pixel values is reduced if an interpolation filtering process using 4×2 subblocks is performed. Accordingly, similarly, as compared to a case that 4×4 subblocks are used, by using 8×4 subblocks, the number of pixel values necessary for an interpolation filtering process to determine the same number of pixel values can be reduced.

In this manner, by using subblocks which are obtained by dividing a block into 8×4 or 4×8 subblocks which are larger than subblocks that are obtained by dividing a block into 4×4 subblocks, for example, the memory access amount, and the processing amount of an interpolation filter that are necessary for generating one pixel can be reduced. On the other hand, because the granularity of subblocks becomes larger, it is expected that the prediction performance deteriorates along with an increase of error in motion compensation of an affine transformation. In view of this, rectangular shapes are adopted in order to keep the granularity as small as possible.

Here, types of rectangular subblock are explained with reference to FIG. 7 and FIG. 8.

FIG. 7 depicts how it appears when an affine transformation accompanying a rotation operation is performed in Type 1 in which the shape of subblocks is 8×4. Similarly, FIG. 8 depicts how it appears when an affine transformation accompanying a rotation operation is performed in Type 2 in which the shape of subblocks is 4×8. That is, rectangular subblocks whose longitudinal direction coincides with the X direction as depicted in FIG. 7 are referred to as Type-1 subblocks, and rectangular subblocks whose longitudinal direction coincides with the Y direction as depicted in FIG. 8 are referred to as Type-2 subblocks.

Then, the encoding circuit 23 switchingly uses Type-1 and Type-2 as the shape of subblocks so as to reduce prediction errors. For example, regarding three vertices of a coding unit, when an X-direction vector difference based on a difference between an X-direction component of a motion vector of the upper left vertex, and an X-direction component of a motion vector of the upper right vertex is smaller than a Y-direction vector difference based on a difference between a Y-direction component of a motion vector of the upper left vertex and a Y-direction component of a motion vector of the lower left vertex, Type 1 with 8×4 is used because differences between motion vectors of subblocks that are arranged next to each other in the X direction are smaller. On the other hand, regarding three vertices of a coding unit, when an X-direction vector difference based on a difference between an X-direction component of a motion vector of the upper left vertex, and an X-direction component of a motion vector of the upper right vertex is equal to or smaller than a Y-direction vector difference based on a difference between a Y-direction component of a motion vector of the upper left vertex and a Y-direction component of a motion vector of the lower left vertex, Type 2 with 4×8 is used because differences between motion vectors of subblocks that are arranged next to each other in the Y direction are smaller. That is, there is a characteristic that if a difference between motion vectors between subblocks is smaller, this means that the influence that occurs when the motion vectors are restricted such that those motion vectors become the same becomes smaller, and by using this characteristic, it is possible to suppress image quality degradation.

Specifically, as depicted in FIG. 7 and FIG. 8, the motion vector v₁ (v₁ₓ, v_{1y}) of the upper left vertex of the coding unit, the motion vector v₂ (v₂ₓ, v_{2y}) of the upper right vertex of the coding unit, and the motion vector v₃ (v₃ₓ, v_{3y}) of the lower left vertex of the coding unit are used to perform calculations of the following Formula (1). Then, in accordance with the magnitude relation of the absolute values of an X-direction vector difference dvₓ and a Y-direction vector difference dv_{y} determined by these calculations, Type 1 and Type 2 are used switchingly.

$$[ Math . 1 ]$$

$$\{ \begin{matrix}{dv}_{x} = \frac{( {v}_{2 x} - {v}_{1 x} )}{W} \\ {dv}_{y} = \frac{( {v}_{3 y} - {v}_{1 y} )}{H}\end{matrix} \qquad ( 1 )$$

That is, in a case that the absolute value of the X-direction vector difference dvₓ is smaller than the absolute value of the Y-direction vector difference dv_{y}, subblocks with Type-1 shape are used, and in a case that the absolute value of the X-direction vector difference dvₓ is equal to or larger than the absolute value of the Y-direction vector difference dv_{y}, subblocks with Type-2 shape are used.

Thereby, it is possible to reduce prediction performance deterioration even if the processing amount of an inter-prediction process is reduced, and it is possible to suppress image quality degradation.

Furthermore, when the prediction direction is Bi-prediction, the processing amount increases. Accordingly, in the case of Uni-prediction that requires a smaller processing amount, 4×4 subblocks may be used, and in the case of Bi-prediction that requires a larger processing amount, 8×4 or 4×8 subblocks may be used.

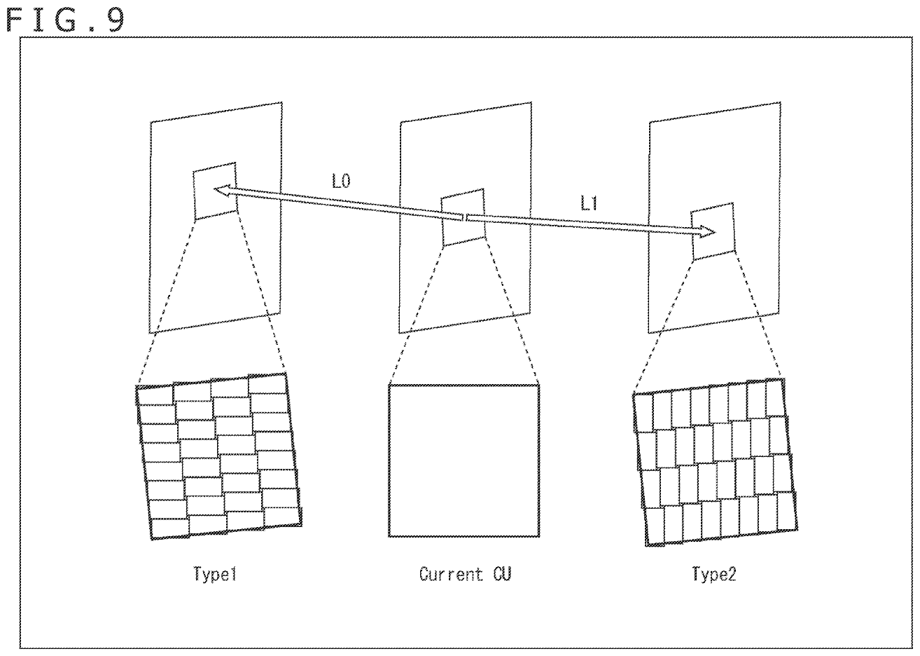

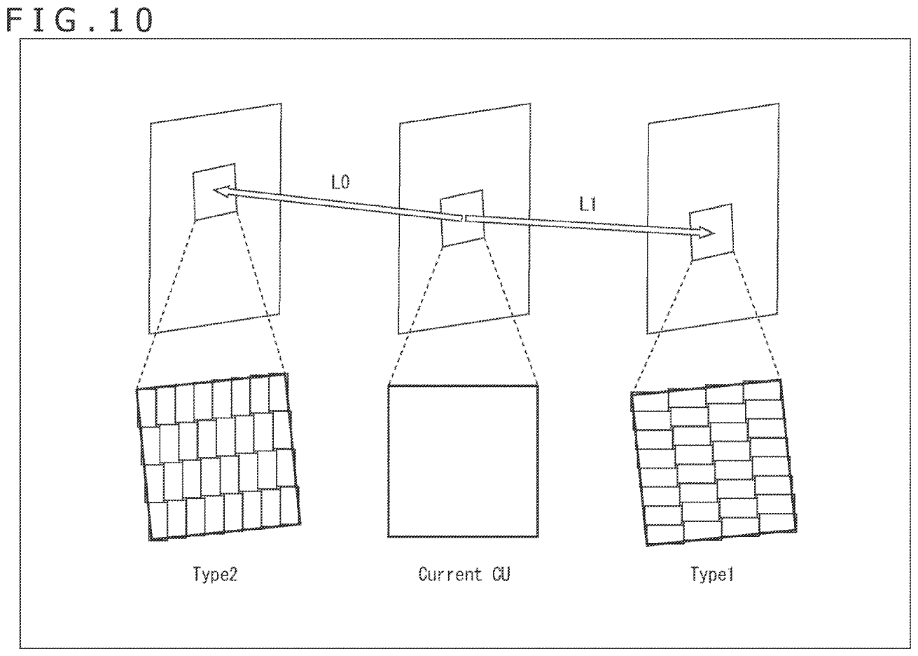

Then, when the prediction direction is Bi-prediction, subblocks with Type-1 shape are used for L0 prediction, and subblocks with Type-2 shape are used for L1 prediction as depicted in FIG. 9. Alternatively, when the prediction direction is Bi-prediction, subblocks with Type-2 shape are used for L0 prediction, and subblocks with Type-1 shape are used for L1 prediction as depicted in FIG. 10.

In this manner, because the alignment of the boundaries of subblocks of Type 1 (width direction) and Type 2 (height direction) is different between L1 prediction and L0 prediction, it is expected that it is attempted to reduce prediction errors when averaging is performed by the averaging section 38 (B in FIG. 5). That is, by preventing the boundaries of subblocks for L1 prediction and L0 prediction from overlapping, it is possible, for example, to prevent noise at the boundaries from being amplified. As a result, image quality deterioration can be suppressed.

Furthermore, when the prediction direction is Bi-prediction, Type 1 and Type 2 may be used switchingly in accordance with the magnitude relation of the absolute values of the X-direction vector difference dvₓ and the Y-direction vector difference dv_{y} as mentioned above for each of L0 prediction and L1 prediction. However, in this case, it is expected that if subblocks of the same type are used for L0 prediction and L1 prediction, noise becomes noticeable at the boundaries of subblocks.

In view of this, by using different types of subblock for L0 prediction and L1 prediction, it is possible to prevent noise at the boundaries of subblocks from becoming noticeable, and suppress image quality deterioration.

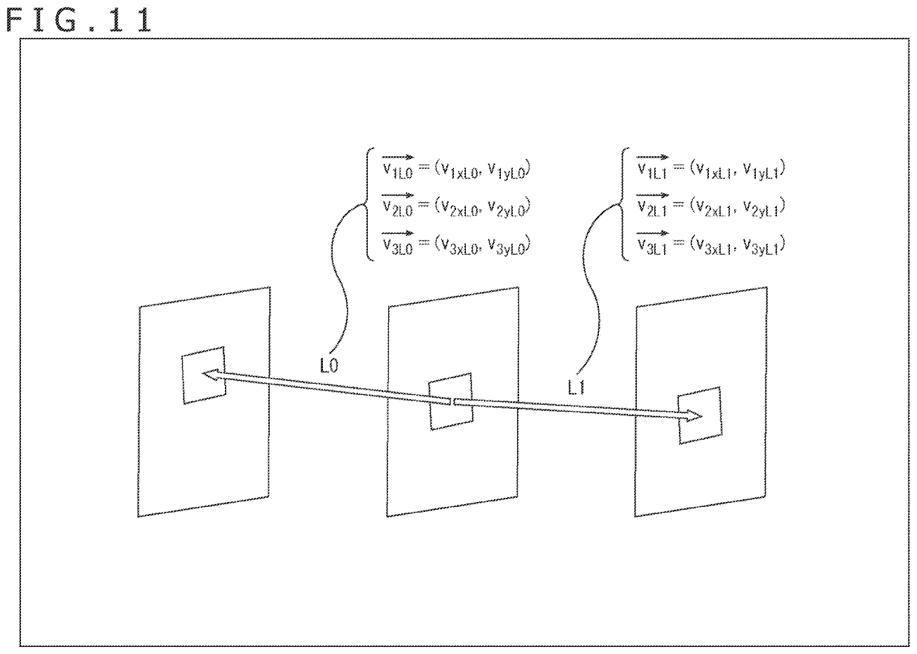

For example, by using a motion vector v_{1L0} of the upper left vertex of L0 prediction, a motion vector v2L0 of the upper right vertex of L0 prediction, and a motion vector v3L0 of the lower left vertex of L0 prediction like the ones depicted in FIG. 11 to perform calculations of the following Formula (2), an X-direction vector difference dv_{xL0} of L0 prediction, and a Y-direction vector difference dv_{yL0} of L0 prediction are determined. Similarly, by using a motion vector v_{1L1} of the upper left vertex of L1 prediction, a motion vector v2L1 of the upper right vertex of L0 prediction, and a motion vector v3L1 of the lower left vertex of L0 prediction like the ones depicted in FIG. 11 to perform calculations of the following Formula (2), an X-direction vector difference dv_{xL1} of L1 prediction, and a Y-direction vector difference dv_{yL1} of L1 prediction are determined.

$$[ Math . 2 ]$$

$$\{ \begin{matrix}{dv}_{xL 0} = \frac{( {v}_{2 xL 0} - {v}_{1 xL 0} )}{W} \\ {dv}_{yL 0} = \frac{( {v}_{3 yL 0} - {v}_{1 yL 0} )}{H} \\ {dv}_{xL 1} = \frac{( {v}_{2 xL 1} - {v}_{1 xL 1} )}{W} \\ {dv}_{yL 1} = \frac{( {v}_{3 yL 1} - {v}_{1 yL 1} )}{H}\end{matrix} \qquad ( 2 )$$

Then, Type 1 and Type 2 are used switchingly in accordance with the magnitude relation of the X-direction vector difference dv_{xL0} of L0 prediction, the Y-direction vector difference dv_{yL0} of L0 prediction, the X-direction vector difference dv_{XL1} of L1 prediction, and the Y-direction vector difference dv_{yL1} of L1 prediction that are determined in such a way.

For example, in a case that the X-direction vector difference dv_{xL0} of L0 prediction or the Y-direction vector difference dv_{yL1} of L1 prediction is the largest, Type-2 subblocks are used for L0 prediction, and Type-1 subblocks are used for L1 prediction. In addition, in a case that the Y-direction vector difference dv_{yL0} of L0 prediction or the X-direction vector difference dv_{yL1} of L1 prediction is the largest, Type-1 subblocks are used for L0 prediction, and Type-2 subblocks are used for L1 prediction.

Thereby, it is possible to further suppress image quality deterioration.

<Configuration Example of Image Encoding Apparatus>

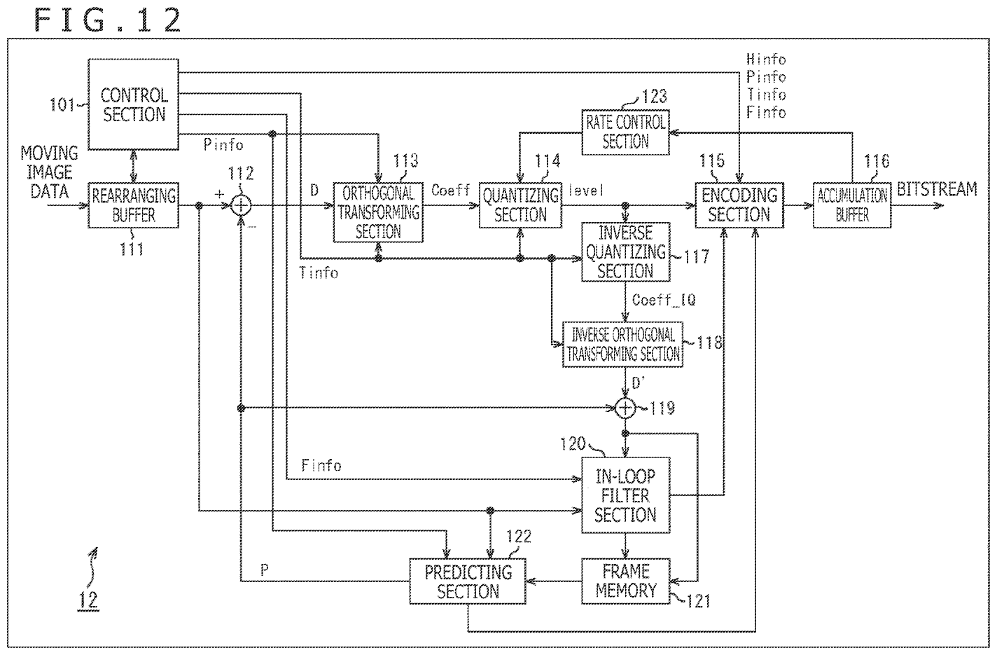

FIG. 12 is a block diagram depicting a configuration example of one embodiment of the image encoding apparatus to which the present technology is applied.

The image encoding apparatus 12 depicted in FIG. 12 is an apparatus that encodes image data of a moving image. For example, the image encoding apparatus 12 implements a technology described in NPL 1, NPL 2, or NPL 3, and encodes image data of a moving image by a method conforming to a standard described in any of the documents.

Note that major ones of processing sections, data flows and the like are depicted in FIG. 12, and those depicted in FIG. 12 are not necessarily the only ones. That is, in the image encoding apparatus 12, there may be processing sections that are not depicted as blocks in FIG. 12, or there may be processes or data flows that are not depicted as arrows or the like in FIG. 12.

As depicted in FIG. 12, the image encoding apparatus 12 includes a control section 101, a rearranging buffer 111, a calculating section 112, an orthogonal transforming section 113, a quantizing section 114, an encoding section 115, an accumulation buffer 116, an inverse quantizing section 117, an inverse orthogonal transforming section 118, a calculating section 119, an in-loop filter section 120, a frame memory 121, a predicting section 122, and a rate control section 123. Note that the predicting section 122 includes an intra-prediction section, and an inter-prediction section that are not depicted. The image encoding apparatus 12 is an apparatus for generating encoded data (bitstream) by encoding moving image data.

<Control Section>

On the basis of a block size which is a processing unit specified externally or specified in advance, the control section 101 divides moving image data retained by the rearranging buffer 111 into blocks of the processing unit (CUs, PUs, transformation blocks, etc.). In addition, on the basis of RDO (Rate-Distortion Optimization), for example, the control section 101 decides an encoding parameter (header information Hinfo, prediction mode information Pinfo, transformation information Tinfo, filter information Finfo, etc.) to be supplied to blocks.

Details of these encoding parameters are mentioned below. Upon deciding encoding parameters like the ones above, the control section 101 supplies them to blocks. The specifics are as follows.

The header information Hinfo is supplied to each block.

The prediction mode information Pinfo is supplied to the encoding section 115, and the predicting section 122.

The transformation information Tinfo is supplied to the encoding section 115, the orthogonal transforming section 113, the quantizing section 114, the inverse quantizing section 117, and the inverse orthogonal transforming section 118.

The filter information Finfo is supplied to the in-loop filter section 120.

Furthermore, as mentioned above with reference to FIG. 2, when setting the processing unit, the control section 101 can set the subblock size identification information identifying the size and the shape of subblocks. Then, the control section 101 also supplies the subblock size identification information to the encoding section 115.

<Rearranging Buffer>

The image encoding apparatus 12 receives an input of each field (input image) of moving image data in a reproduction order (display order) of the fields. The rearranging buffer 111 acquires each input image in the reproduction order (display order) of the input images, and retains (stores) them. Under the control of the control section 101, the rearranging buffer 111 rearranges the input images in the encoding order (decoding order), divides the input images into blocks of the processing unit, and so on. The rearranging buffer 111 supplies each input image after being subjected to the processes to the calculating section 112. In addition, the rearranging buffer 111 also supplies the input images (original images) to the predicting section 122 and the in-loop filter section 120.

<Calculating Section>

The calculating section 112 receives, as inputs, an image I corresponding to a block of the processing unit, and a prediction image P supplied from the predicting section 122, subtracts the prediction image P from the image I, derives a prediction residue D (D=I−P), and supplies the prediction residue D to the orthogonal transforming section 113.

<Orthogonal Transforming Section>

The orthogonal transforming section 113 receives, as inputs, the prediction residue D supplied from the calculating section 112, and the transformation information Tinfo supplied from the control section 101, and performs an orthogonal transformation on the prediction residue D on the basis of the transformation information Tinfo, and derives a transformation coefficient Coeff. The orthogonal transforming section 113 supplies the obtained transformation coefficient Coeff to the quantizing section 114.

<Quantizing Section>

The quantizing section 114 receives, as inputs, the transformation coefficient Coeff supplied from the orthogonal transforming section 113, and the transformation information Tinfo supplied from the control section 101, and performs scaling (quantization) of the transformation coefficient Coeff on the basis of the transformation information Tinfo. Note that the rate of this quantization is controlled by the rate control section 123. The quantizing section 114 supplies the transformation coefficient after the quantization obtained by such quantization, that is, a quantization transformation coefficient level level, to the encoding section 115 and the inverse quantizing section 117.

<Encoding Section>

The encoding section 115 receives, as inputs, the quantization transformation coefficient level level supplied from the quantizing section 114, the various types of encoding parameter (the header information Hinfo, the prediction mode information Pinfo, the transformation information Tinfo, the filter information Finfo, etc.) supplied from the control section 101, information regarding a filter such as a filter coefficient supplied from the in-loop filter section 120, and information regarding an optimum prediction mode supplied from the predicting section 122. The encoding section 115 performs variable-length encoding (e.g. arithmetic encoding) on the quantization transformation coefficient level level, and generates a bit string (encoded data).

In addition, the encoding section 115 derives residual information Rinfo from the quantization transformation coefficient level level, encodes the residual information Rinfo, and generates a bit string.

Furthermore, the encoding section 115 includes, in the filter information Finfo, the information regarding the filter supplied from the in-loop filter section 120, and includes, in the prediction mode information Pinfo, the information regarding the optimum prediction mode supplied from the predicting section 122. Then, the encoding section 115 encodes the various types of encoding parameter (the header information Hinfo, the prediction mode information Pinfo, the transformation information Tinfo, the filter information Finfo, etc.) mentioned above, and generates a bit string.

In addition, the encoding section 115 multiplexes the thus-generated bit strings of the various types of information, and generates encoded data. The encoding section 115 supplies the encoded data to the accumulation buffer 116.

In addition to them, the encoding section 115 can encode the subblock size identification information supplied from the control section 101, generate a bit string, multiplex the bit string, and generate encoded data. Thereby, as mentioned above with reference to FIG. 1, the encoded data (bitstream) including the subblock size identification information is transferred.

<Accumulation Buffer>

The accumulation buffer 116 temporarily retains the encoded data obtained at the encoding section 115. At a predetermined timing, the accumulation buffer 116 outputs the retained encoded data to the outside of the image encoding apparatus 12 as a bitstream or the like, for example. For example, the encoded data is transferred to the decoding side via a certain recording medium, a certain transfer medium, a certain information processing apparatus, or the like. That is, the accumulation buffer 116 also is a transferring section that transfers the encoded data (bitstream).

<Inverse Quantizing Section>

The inverse quantizing section 117 performs a process related to inverse quantization. For example, the inverse quantizing section 117 receives, as inputs, the quantization transformation coefficient level level supplied from the quantizing section 114, and the transformation information Tinfo supplied from the control section 101, and performs scaling (inverse quantization) of the value of the quantization transformation coefficient level level on the basis of the transformation information Tinfo. Note that this inverse quantization is an inverse process of the quantization performed at the quantizing section 114. The inverse quantizing section 117 supplies a transformation coefficient Coeff_IQ obtained by such inverse quantization to the inverse orthogonal transforming section 118.

<Inverse Orthogonal Transforming Section>

The inverse orthogonal transforming section 118 performs a process related to an inverse orthogonal transformation. For example, the inverse orthogonal transforming section 118 receives, as inputs, the transformation coefficient Coeff_IQ supplied from the inverse quantizing section 117, and the transformation information Tinfo supplied from the control section 101, performs an inverse orthogonal transformation on the transformation coefficient Coeff_IQ on the basis of the transformation information Tinfo, and derives a prediction residue D′. Note that this inverse orthogonal transformation is an inverse process of the orthogonal transformation performed at the orthogonal transforming section 113. The inverse orthogonal transforming section 118 supplies the prediction residue D′ obtained by such an inverse orthogonal transformation to the calculating section 119. Note that because the inverse orthogonal transforming section 118 is similar to an inverse orthogonal transforming section (mentioned below) on the decoding side, an explanation (mentioned below) that is given about the decoding side can be applied to the inverse orthogonal transforming section 118.

<Calculating Section>

The calculating section 119 receives, as inputs, the prediction residue D′ supplied from the inverse orthogonal transforming section 118, and the prediction image P supplied from the predicting section 122. The calculating section 119 adds together the prediction residue D′, and the prediction image P corresponding to the prediction residue D′, and derives a locally-decoded image R_{local} (R_{local}=D′+P). The calculating section 119 supplies the derived locally-decoded image R_{local} to the in-loop filter section 120 and the frame memory 121.

<In-Loop Filter Section>

The in-loop filter section 120 performs a process related to an in-loop filtering process. For example, the in-loop filter section 120 receives, as inputs, the locally-decoded image R_{local} supplied from the calculating section 119, the filter information Finfo supplied from the control section 101, and the input image (original image) supplied from the rearranging buffer 111. Note that information input to the in-loop filter section 120 can be any information, and information other than these pieces of information may be input. For example, as necessary, information regarding a prediction mode, motion information, an encoding amount target value, a quantization parameter QP, a picture type, or a block (CU, CTU, etc.), or the like may be input to the in-loop filter section 120.

The in-loop filter section 120 performs a filtering process as appropriate on the locally-decoded image R_{local} on the basis of the filter information Finfo. As necessary, the in-loop filter section 120 uses also the input image (original image), and other types of input information for the filtering process.

For example, the in-loop filter section 120 applies four in-loop filters, a bilateral filter, a deblocking filter (DBF (DeBlocking Filter)), an adaptive offset filter (SAO (Sample Adaptive Offset)) and an adaptive loop filter (ALF (Adaptive Loop Filter)), in this order as described in NPL 1. Note that filters to be applied can be any filters, and an order in which the filters are applied can be any order. These can be selected as appropriate.

Certainly, the filtering process performed by the in-loop filter section 120 can be any filtering process, and is not limited to the example mentioned above. For example, the in-loop filter section 120 may apply the Wiener filter or the like.

The in-loop filter section 120 supplies the locally-decoded image R_{local} having been subjected to the filtering process to the frame memory 121. Note that, for example, in a case that information regarding filters such as filter coefficients is transferred to the decoding side, the in-loop filter section 120 supplies the information regarding the filters to the encoding section 115.

<Frame Memory>

The frame memory 121 performs a process related to the storage of data related to an image. For example, the frame memory 121 receives, as inputs, the locally-decoded image R_{local} supplied from the calculating section 119, and the locally-decoded image R_{local} having been subjected to the filtering process supplied from the in-loop filter section 120, and retains (stores) them. In addition, the frame memory 121 reconstructs the decoded image R for each picture unit by using the locally-decoded image R_{local}, and retains the decoded image R (stores it in a buffer in the frame memory 121). The frame memory 121 supplies the decoded image R (or part thereof) to the predicting section 122 in accordance with a request from the predicting section 122.

<Predicting Section>

The predicting section 122 performs a process related to generation of a prediction image. For example, the predicting section 122 receives, as inputs, the prediction mode information Pinfo supplied from the control section 101, the input image (original image) supplied from the rearranging buffer 111, and the decoded image R (or part thereof) read out from the frame memory 121. The predicting section 122 performs a prediction process such as an inter-prediction or an intra-prediction by using the prediction mode information Pinfo or the input image (original image), performs a prediction by referring to the decoded image R as a reference image, performs a motion compensation process on the basis of a result of the prediction, and generates the prediction image P. The predicting section 122 supplies the generated prediction image P to the calculating section 112 and the calculating section 119. In addition, as necessary the predicting section 122 supplies the encoding section 115 with information regarding a prediction mode selected in the processes above, that is, an optimum prediction mode.

Here, when performing such an inter-prediction process, the predicting section 122 can switch the size and the shape of subblocks as mentioned above with reference to FIG. 2.

<Rate Control Section>

The rate control section 123 performs a process related to rate control. For example, the rate control section 123 controls the rate of a quantization operation of the quantizing section 114 such that an overflow or an underflow does not occur, on the basis of the encoding amount of encoded data accumulated in the accumulation buffer 116.

In the thus-configured image encoding apparatus 12, the control section 101 sets the subblock size identification information identifying the size and the shape of subblocks, and the encoding section 115 generates encoded data including the subblock size identification information. In addition, the predicting section 122 performs an inter-prediction process while switching the size and the shape of subblocks. Accordingly, by using larger subblocks or by using rectangular subblocks, the image encoding apparatus 12 can reduce the processing amount in an inter-prediction process, and also suppress image quality deterioration.

Note that each process performed at the encoding circuit 23, as the setting section and the encoding section, like the ones mentioned above with reference to FIG. 2 may not be performed individually in each block depicted in FIG. 12, but may be performed by a plurality of blocks, for example.

<Configuration Example of Image Decoding Apparatus>

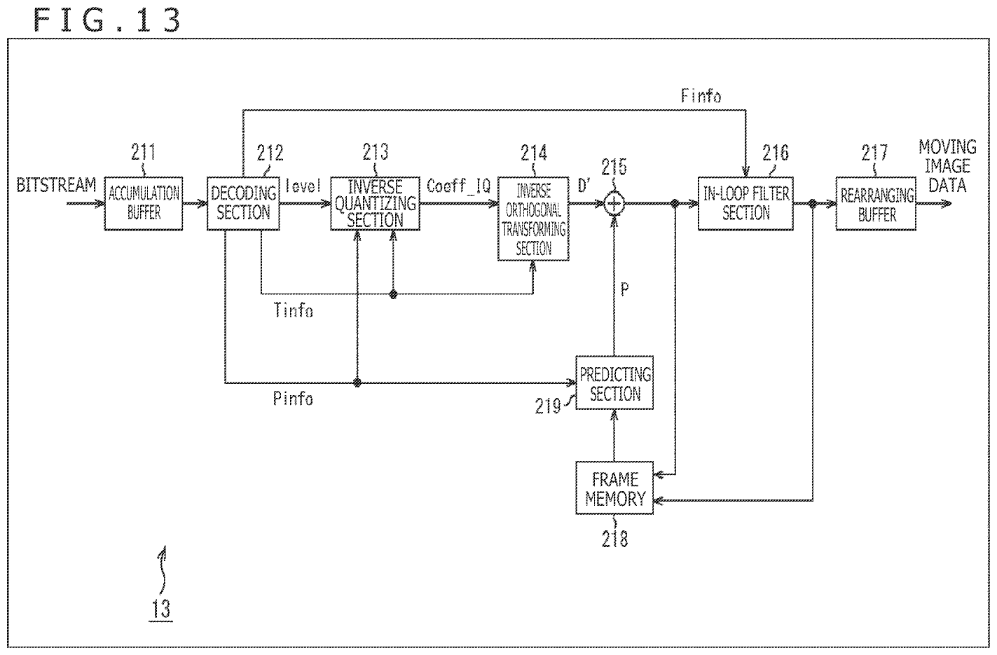

FIG. 13 is a block diagram depicting a configuration example of one embodiment of the image decoding apparatus to which the present technology is applied. The image decoding apparatus 13 depicted in FIG. 13 is an apparatus that decodes encoded data in which a prediction residue of an image and its prediction image is encoded as in AVC or HEVC. For example, the image decoding apparatus 13 implements a technology described in NPL 1, NPL 2 or NPL 3, and decodes encoded data in which image data of a moving image is encoded by a method conforming to a standard described in any of the documents. For example, the image decoding apparatus 13 decodes encoded data (bitstream) generated by the image encoding apparatus 12 mentioned above.

Note that major ones of processing sections, data flows and the like are depicted in FIG. 13, and those depicted in FIG. 13 are not necessarily the only ones. That is, in the image decoding apparatus 13, there may be processing sections that are not depicted as blocks in FIG. 13, or there may be processes or data flows that are not depicted as arrows or the like in FIG. 13.

In FIG. 13, the image decoding apparatus 13 includes an accumulation buffer 211, a decoding section 212, an inverse quantizing section 213, an inverse orthogonal transforming section 214, a calculating section 215, an in-loop filter section 216, a rearranging buffer 217, a frame memory 218, and a predicting section 219. Note that the predicting section 219 includes an intra-prediction section, and an inter-prediction section that are not depicted. The image decoding apparatus 13 is an apparatus for generating moving image data by decoding encoded data (bitstream).

<Accumulation Buffer>

The accumulation buffer 211 acquires a bitstream input to the image decoding apparatus 13, and retains (store) it. At a predetermined timing, or in a case that a predetermined condition is satisfied or in other similar cases, the accumulation buffer 211 supplies the accumulated bitstream to the decoding section 212.

<Decoding Section>

The decoding section 212 performs a process related to decoding of an image. For example, the decoding section 212 receive, as an input, a bitstream supplied from the accumulation buffer 211, performs variable-length decoding of a syntax value of each syntax element from the bit string in accordance with the definition of a syntax table, and derives a parameter.

The parameters derived from the syntax elements, and the syntax values of the syntax elements include information such as the header information Hinfo, the prediction mode information Pinfo, the transformation information Tinfo, the residual information Rinfo, or the filter information Finfo, for example. That is, the decoding section 212 parses the bitstream to obtain these pieces of information (analyzes the bitstream to acquire these pieces of information). These pieces of information are explained below.

<Header Information Hinfo>

The header information Hinfo includes header information such as VPS (Video Parameter Set)/SPS (Sequence Parameter Set)/PPS (Picture Parameter Set)/SH (slice header), for example. The header information Hinfo includes information defining image sizes (a width PicWidth, a height PicHeight), bit depths (a luminance bitDepthY, a color difference bitDepthC), a color difference array type ChromaArrayType, the maximum value MaxCUSize/minimum value MinCUSize of CU sizes, the maximum depth MaxQTDepth/minimum depth MinQTDepth of quad-tree division (also referred to as Quad-tree division), the maximum depth MaxBTDepth/minimum depth MinBTDepth of binary-tree division (Binary-tree division), the maximum value MaxTSSize of transformation skip blocks (also referred to as the maximum transformation skip block size), an On/Off flag of each encoding tool (also referred to as a validity flag), and the like, for example.

For example, On/Off flags of encoding tools included in the header information Hinfo include an On/Off flag related to transformation and quantization processes depicted below. Note that the On/Off flags of the encoding tools can be interpreted as being flags representing whether or not there is syntax related to the encoding tools in the encoded data. In addition, in a case that the value of an On/Off flag is 1 (true), this represents that the encoding tool is available, and in a case that the value of the On/Off flag is 0 (false), this represents that the encoding tool is unavailable. Note that the interpretation of flag values may be opposite.

A cross-component prediction validity flag (ccp_enabled_flag): flag information representing whether or not a cross-component prediction (CCP (Cross-Component Prediction), also referred to as a CC prediction) is available. For example, in a case that the flag information is set to “1” (true), this represents that the prediction is available, and in a case that the flag information is set to “0” (false), this represents that the prediction is unavailable.

Note that this CCP is also referred to as a cross-component linear prediction (CCLM or CCLMP).

<Prediction Mode Information Pinfo>

The prediction mode information Pinfo includes information such as the size information PBSize (prediction block size) of a processing-target PB (prediction block), an intra-prediction mode information IPinfo or motion prediction information MVinfo, for example.

The intra-prediction mode information IPinfo includes prev_intra_luma_pred_flag, mpm_idx, and rem_intra_pred_mode in JCTVC-W1005, 7.3.8.5 Coding Unit syntax, a luminance intra-prediction mode IntraPredModeY derived from the syntax, and the like, for example.

In addition, the intra-prediction mode information IPinfo includes a cross-component prediction flag (ccp_flag (cclmp_flag)), a multi-class linear prediction mode flag (mclm_flag), a color difference sample position type identifier (chroma_sample_loc_type_idx) and a color difference MPM identifier (chroma_mpm_idx), a luminance intra-prediction mode (IntraPredModeC) derived from the syntax, and the like, for example.

The cross-component prediction flag (ccp_flag (cclmp_flag)) is flag information representing whether to or not to apply a cross-component linear prediction. For example, when ccp_flag==1, this represents that a cross-component prediction is applied, and when ccp_flag==0, this represents that a cross-component prediction is not applied.

The multi-class linear prediction mode flag (mclm_flag) is information (linear prediction mode information) related to a linear prediction mode. More specifically, the multi-class linear prediction mode flag (mclm_flag) is flag information representing whether or not the mode is a multi-class linear prediction mode. For example, in a case that the multi-class linear prediction mode flag is set to “0,” this represents that the mode is a 1-class mode (single class mode) (e.g. CCLMP), and in a case that the multi-class linear prediction mode flag is set to “1,” this represents that the mode is a 2-class mode (multi-class mode) (e.g. MCLMP).

The color difference sample position type identifier (chroma_sample_loc_type_idx) is an identifier that identifies a type (also referred to as a color difference sample position type) of the pixel position of a color difference component. For example, in a case that a color difference array type (ChromaArrayType) which is information regarding a color format represents 420 format, the color difference sample position type identifier is allocated in the following manner.

chroma_sample_loc_type_idx==0: Type2

chroma_sample_loc_type_idx==1: Type3

chroma_sample_loc_type_idx==2: Type0

chroma_sample_loc_type_idx==3: Type1

Note that this color difference sample position type identifier (chroma_sample_loc_type_idx) is transferred as information (chroma_sample_loc_info( )) related to the pixel position of the color difference component (while being stored in the information).

The color difference MPM identifier (chroma_mpm_idx) is an identifier representing which prediction mode candidate in a color difference intra-prediction mode candidate list (intraPredModeCandListC) is specified as the color difference intra-prediction mode.

The motion prediction information MVinfo includes information such as merge_idx, merge_flag, inter_pred_idc, ref_idx_LX, mvp_lX_flag, X={0,1}, or mvd (see JCTVC-W1005, 7.3.8.6 Prediction Unit Syntax, for example), for example.

Certainly, information included in the prediction mode information Pinfo can be any information, and information other than these pieces of information may be included.

<Transformation Information Tinfo>

The transformation information Tinfo includes the following information, for example. Certainly, information included in the transformation information Tinfo can be any information, and information other than these pieces of information may be included.

Width size TBWSize and height TBHSize of a processing-target transformation block (or these may be logarithmic values log 2TBWSize and log 2TBHSize of TBWSize and TBHSize, respectively, whose base is 2)

Transformation skip flag (ts_flag): a flag representing whether to or not to skip a (an inverse) primary transformation, and a (an inverse) secondary transformation.

Scan identifier (scanIdx)

Quantization parameter (qp)

Quantization matrix (scaling_matrix (e.g. JCTVC-W1005, 7.3.4 Scaling list data syntax))

<Residual Information Rinfo>

The residual information Rinfo (see 7.3.8.11 Residual Coding syntax in JCTVC-W1005, for example) includes the following syntax, for example.

cbf (coded_block_flag): a residual data presence/absence flag

last_sig_coeff_x_pos: a last non-zero coefficient X coordinate

last_sig_coeff_y_pos: a last non-zero coefficient Y coordinate

coded_sub_block_flag: a subblock non-zero coefficient presence/absence flag

sig_coeff_flag: a non-zero coefficient presence/absence flag

gr1_flag: a flag representing whether or not the level of a non-zero coefficient is larger than 1 (also referred to as a GR1 flag)

gr2_flag: a flag representing whether or not the level of the non-zero coefficient is larger than 2 (also referred to as a GR2 flag)

sign_flag: a sign representing whether the non-zero coefficient is a positive coefficient or a negative coefficient (also referred to as a sign)

coeff_abs_level_remaining: a residual level of the non-zero coefficient (also referred to as a non-zero coefficient residual level)

etc.

Certainly, information included in the residual information Rinfo can be any information, and information other than these pieces of information may be included.

<Filter Information Finfo>

The filter information Finfo includes control information regarding each filtering process depicted below, for example.

Control information regarding deblocking filter (DBF)

Control information regarding pixel adaptive offset (SAO)

Control information regarding adaptive loop filter (ALF)

Control information regarding other linear/non-linear filters

More specifically, the filter information Finfo includes information specifying a picture, or an area in a picture to which each filter is applied, filter On/Off control information for each CU, filter On/Off control information regarding the boundaries of slices and tiles, and the like, for example. Certainly, information included in the filter information Finfo can be any information, and information other than these pieces of information may be included.

Returning to the explanation of the decoding section 212, the decoding section 212 derives the quantization transformation coefficient level level of each coefficient position in each transformation block by referring to the residual information Rinfo. The decoding section 212 supplies the quantization transformation coefficient level level to the inverse quantizing section 213.

In addition, the decoding section 212 supplies the header information Hinfo, prediction mode information Pinfo, quantization transformation coefficient level level, transformation information Tinfo, and filter information Finfo obtained by parsing to blocks. The specifics are as follows.

The header information Hinfo is supplied to the inverse quantizing section 213, the inverse orthogonal transforming section 214, the predicting section 219, and the in-loop filter section 216.

The prediction mode information Pinfo is supplied to the inverse quantizing section 213, and the predicting section 219.

The transformation information Tinfo is supplied to the inverse quantizing section 213, and the inverse orthogonal transforming section 214.

The filter information Finfo is supplied to the in-loop filter section 216.

Certainly, the examples mentioned above are examples, and those are not the sole examples. For example, each encoding parameter may be supplied to any processing section. In addition, other information may be supplied to any processing section.

Furthermore, in a case that the subblock size identification information identifying the size and the shape of subblocks is included in a bitstream, the decoding section 212 can obtain the subblock size identification information by parsing.

<Inverse Quantizing Section>

The inverse quantizing section 213 performs a process related to inverse quantization. For example, the inverse quantizing section 213 receives, as inputs, the transformation information Tinfo and the quantization transformation coefficient level level supplied from the decoding section 212, performs scaling (inverse quantization) of the value of the quantization transformation coefficient level level on the basis of the transformation information Tinfo, and derives the transformation coefficient Coeff_IQ having been subjected to the inverse quantization.

Note that this inverse quantization is performed as an inverse process of the quantization by the quantizing section 114. In addition, this inverse quantization is a process similar to the inverse quantization by the inverse quantizing section 117. That is, the inverse quantizing section 117 performs a process (inverse quantization) similar to the process performed by the inverse quantizing section 213.

The inverse quantizing section 213 supplies the derived transformation coefficient Coeff_IQ to the inverse orthogonal transforming section 214.

<Inverse Orthogonal Transforming Section>

The inverse orthogonal transforming section 214 performs a process related to an inverse orthogonal transformation. For example, the inverse orthogonal transforming section 214 receives, as inputs, the transformation coefficient Coeff_IQ supplied from the inverse quantizing section 213, and the transformation information Tinfo supplied from the decoding section 212, performs an inverse orthogonal transformation process on the transformation coefficient Coeff_IQ on the basis of the transformation information Tinfo, and derives a prediction residue D′.

Note that this inverse orthogonal transformation is performed as an inverse process of the orthogonal transformation performed by the orthogonal transforming section 113. In addition, this inverse orthogonal transformation is a process similar to the inverse orthogonal transformation performed by the inverse orthogonal transforming section 118. That is, the inverse orthogonal transforming section 118 performs a process (inverse orthogonal transformation) similar to the process performed by the inverse orthogonal transforming section 214.

The inverse orthogonal transforming section 214 supplies the derived prediction residue D′ to the calculating section 215.

<Calculating Section>

The calculating section 215 performs a process related to addition of information regarding an image. For example, the calculating section 215 receives, as inputs, the prediction residue D′ supplied from the inverse orthogonal transforming section 214, and the prediction image P supplied from the predicting section 219. The calculating section 215 adds together the prediction residue D′, and the prediction image P (prediction signal) corresponding to the prediction residue D′, and derives the locally-decoded image R_{local} (R_{local}=D′+P).

The calculating section 215 supplies the derived locally-decoded image R_{local} to the in-loop filter section 216 and the frame memory 218.

<In-Loop Filter Section>

The in-loop filter section 216 performs a process related to an in-loop filtering process. For example, the in-loop filter section 216 receives, as inputs, the locally-decoded image R_{local} supplied from the calculating section 215, and the filter information Finfo supplied from the decoding section 212. Note that information input to the in-loop filter section 216 can be any information, and information other than these pieces of information may be input.

The in-loop filter section 216 performs a filtering process as appropriate on the locally-decoded image R_{local} on the basis of the filter information Finfo.

For example, the in-loop filter section 216 applies four in-loop filters, a bilateral filter, a deblocking filter (DBF (DeBlocking Filter)), an adaptive offset filter (SAO (Sample Adaptive Offset)), and an adaptive loop filter (ALF (Adaptive Loop Filter)), in this order as described in NPL 1. Note that filters to be applied can be any filters, and an order in which the filters are applied can be any order. These can be selected as appropriate.

The in-loop filter section 216 performs the filtering process corresponding to the filtering process performed by the encoding side (e.g. the in-loop filter section 120 of the image encoding apparatus 12 in FIG. 12).

Certainly, the filtering process performed by the in-loop filter section 216 can be any filtering process, and is not limited to the example mentioned above. For example, the in-loop filter section 216 may apply the Wiener filter or the like.

The in-loop filter section 216 supplies the locally-decoded image R_{local} having been subjected to the filtering process to the rearranging buffer 217 and the frame memory 218.

<Rearranging Buffer>

The rearranging buffer 217 receives, as an input, the locally-decoded image R_{local} supplied from the in-loop filter section 216, and retains (stores) it. The rearranging buffer 217 reconstructs the decoded image R for each picture unit by using the locally-decoded image R_{local}, and retains it (stores it in a buffer). The rearranging buffer 217 rearranges the obtained decoded images R arranged in a decoding order such that the obtained decoded images R are arranged in a reproduction order. The rearranging buffer 217 outputs the rearranged decoded image R group to the outside of the image decoding apparatus 13 as moving image data.

<Frame Memory>

The frame memory 218 performs a process related to the storage of data related to an image. For example, the frame memory 218 receives, as an input, the locally-decoded image R_{local} supplied from the calculating section 215, reconstructs the decoded image R for each picture unit, and stores it in a buffer in the frame memory 218.

In addition, the frame memory 218 receives, as an input, the locally-decoded image R_{local} supplied from the in-loop filter section 216 and having been subjected to the in-loop filtering process, reconstructs the decoded image R for each picture unit, and stores it in a buffer in the frame memory 218. The frame memory 218 supplies the stored decoded images R (or part thereof) to the predicting section 219 as reference images, as appropriate.

Note that the frame memory 218 may store the header information Hinfo, prediction mode information Pinfo, transformation information Tinfo, filter information Finfo, and the like related to generation of decoded images.

<Predicting Section>

The predicting section 219 performs a process related to generation of a prediction image. For example, the predicting section 219 receives, as an input, the prediction mode information Pinfo supplied from the decoding section 212, performs a prediction by a prediction method specified by the prediction mode information Pinfo, and derives the prediction image P. When deriving the prediction image P, the predicting section 219 uses, as a reference image, a decoded image R (or part thereof) before being subjected to filtering or after being subjected to filtering that is specified by the prediction mode information Pinfo, and stored on the frame memory 218. The predicting section 219 supplies the derived prediction image P to the calculating section 215.

Here, when performing the inter-prediction process, the predicting section 219 can switch the size and the shape of subblocks in accordance with the subblock size identification information obtained by parsing of the bitstream by the decoding section 212 as mentioned above with reference to FIG. 3.

In the thus-configured image decoding apparatus 13, the decoding section 212 performs a parsing process of parsing a bitstream to obtain the subblock size identification information. In addition, the predicting section 219 performs an inter-prediction process while switching the size and the shape of subblocks in accordance with the subblock size identification information. Accordingly, by using larger subblocks or by using rectangular subblocks, the image decoding apparatus 13 can reduce the processing amount in an inter-prediction process, and also suppress image quality deterioration.

Note that each process performed at the decoding circuit 33, as the parsing section and the decoding section, like the ones mentioned above with reference to FIG. 3 may not be performed individually in each block depicted in FIG. 13, but may be performed by a plurality of blocks, for example.

<Image Encoding Process and Image Decoding Process>

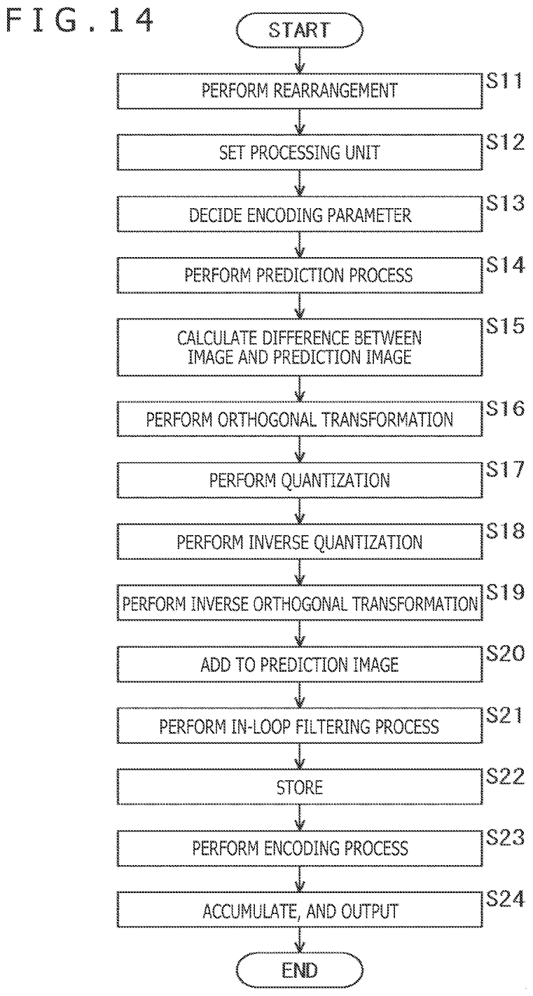

An image encoding process executed by the image encoding apparatus 12, and an image decoding process executed by the image decoding apparatus 13 are explained with reference to flowcharts in FIG. 14 to FIG. 18.

FIG. 14 is a flowchart for explaining the image encoding process executed by the image encoding apparatus 12.

When the image encoding process is started, at Step S11, under the control of the control section 101, the rearranging buffer 111 rearranges frames of input moving image data arranged in a display order such that the frames are arranged in an encoding order.

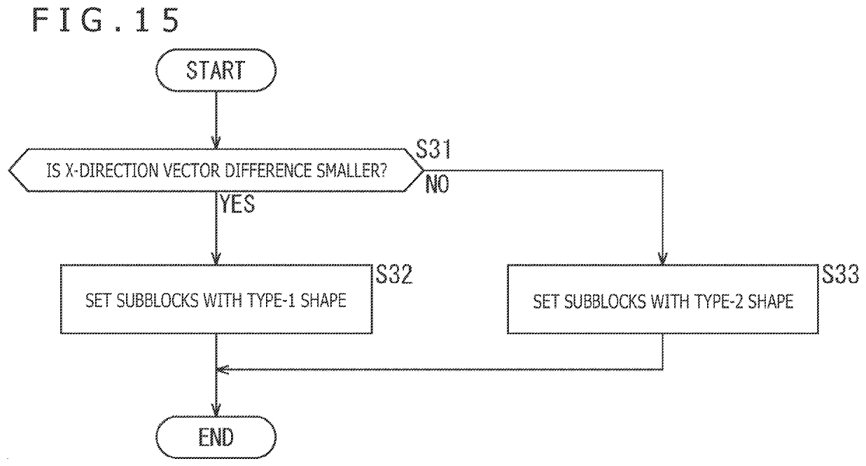

At Step S12, the control section 101 sets a processing unit for (performs block division on) an input image retained in the rearranging buffer 111. Here, when the processing unit is set, a process of setting subblock size identification information like the one mentioned below with reference to FIG. 15 to FIG. 18 is also performed.

At Step S13, the control section 101 decides (sets) an encoding parameter for the input image retained in the rearranging buffer 111.

At Step S14, the predicting section 122 performs a prediction process, and generates a prediction image and the like of an optimum prediction mode. For example, in this prediction process, the predicting section 122 performs an intra-prediction to generate a prediction image and the like of an optimum intra-prediction mode, performs an inter-prediction to generate a prediction image and the like of an optimum inter-prediction mode, and selects an optimum prediction mode from them on the basis of a cost function value and the like. Here, when the prediction process is performed, the size and the shape of subblocks used in the inter-prediction process can be switched as mentioned above with reference to FIG. 2.

At Step S15, the calculating section 112 calculates a difference between the input image, and the prediction image of the optimum mode selected by the prediction process at Step S14. That is, the calculating section 112 generates the prediction residue D of the input image and the prediction image. The thus-determined prediction residue D allows a reduction of the amount of data as compared with the original image data. Accordingly, as compared with the case that an image itself is encoded, the amount of data can be compressed.

At Step S16, the orthogonal transforming section 113 performs an orthogonal transformation process on the prediction residue D generated by the process at Step S15, and derives the transformation coefficient Coeff.

At Step S17, the quantizing section 114 uses the quantization parameter computed by the control section 101, and so on, to quantize the transformation coefficient Coeff obtained by the process at Step S16, and derives the quantization transformation coefficient level level.

At Step S18, by using a characteristic corresponding to a characteristic of the quantization at Step S17, the inverse quantizing section 117 performs inverse quantization on the quantization transformation coefficient level level generated by the process at Step S17, and derives the transformation coefficient Coeff_IQ.

At Step S19, by a method corresponding to the orthogonal transformation process at Step S16, the inverse orthogonal transforming section 118 performs an inverse orthogonal transformation on the transformation coefficient Coeff_IQ obtained by the process at Step S18, and derives the prediction residue D′. Note that because this inverse orthogonal transformation process is similar to an inverse orthogonal transformation process (mentioned below) performed on the decoding side, an explanation (mentioned below) given about the decoding side can be applied to the inverse orthogonal transformation process at Step S19.

At Step S20, the calculating section 119 adds the prediction image obtained by the prediction process at Step S14 to the prediction residue D′ derived by the process at Step S19 to thereby generate a locally-decoded decoded image.

At Step S21, the in-loop filter section 120 performs an in-loop filtering process on the locally-decoded decoded image derived by the process at Step S20.

At Step S22, the frame memory 121 stores the locally-decoded decoded image derived by the process at Step S20, and the locally-decoded decoded image having been subjected to the filtering process at Step S21.

At Step S23, the encoding section 115 encodes the quantization transformation coefficient level level obtained by the process at Step S17. For example, the encoding section 115 encodes the quantization transformation coefficient level level which is information regarding the image by arithmetic encoding or the like, and generates encoded data. In addition, at this time, the encoding section 115 encodes various types of encoding parameter (the header information Hinfo, the prediction mode information Pinfo, and the transformation information Tinfo). Furthermore, the encoding section 115 derives residual information RInfo from the quantization transformation coefficient level level, and encodes the residual information RInfo.

At Step S24, the accumulation buffer 116 accumulates the thus-obtained encoded data, and outputs the encoded data to the outside of the image encoding apparatus 12 as a bitstream, for example. The bitstream is transferred to the decoding side via a transfer path or a recording medium, for example. In addition, the rate control section 123 performs rate control as necessary.

When the process at Step S24 ends, the image encoding process ends.

In the image encoding process with a flow like the one above, processes to which the present technology mentioned above is applied are performed as the processes at Step S12 and Step S14. Accordingly, by executing this image encoding process to use larger subblocks or use rectangular subblocks, it is possible to reduce the processing amount in an inter-prediction process, and also suppress image quality deterioration.

FIG. 15 is a flowchart for explaining a first processing example of the process of setting the subblock size identification information at Step S12 in FIG. 14.

At Step S31, the control section 101 determines whether or not the X-direction vector difference dvₓ is smaller than the Y-direction vector difference dv_{y} on the basis of results of calculations of Formula (1) mentioned above.

In a case that, at Step S31, the control section 101 determines that the X-direction vector difference dvₓ is smaller, the process proceeds to Step S32. Then, at Step S32, the control section 101 sets the subblock size identification information such that subblocks with Type-1 shapes (i.e. rectangular shapes having a longitudinal direction that coincides with the X direction) in FIG. 7 are used, and then the process ends.

On the other hand, in a case that, at Step S31, the control section 101 determines that the X-direction vector difference dvₓ is not smaller (the X-direction vector difference dvₓ is equal to or larger than the Y-direction vector difference dv_{y}), the process proceeds to Step S33. Then, at Step S33, the control section 101 sets the subblock size identification information such that subblocks with Type-2 shapes (i.e. rectangular shapes having a longitudinal direction that coincides with the Y direction) in FIG. 8 are used, and then the process ends.

As mentioned above, the control section 101 can set the subblock size identification information such that the longitudinal direction of rectangular subblocks is switched between the X direction and the Y direction on the basis of the magnitude relation of the Y-direction vector difference dv_{y} and the X-direction vector difference dvₓ.

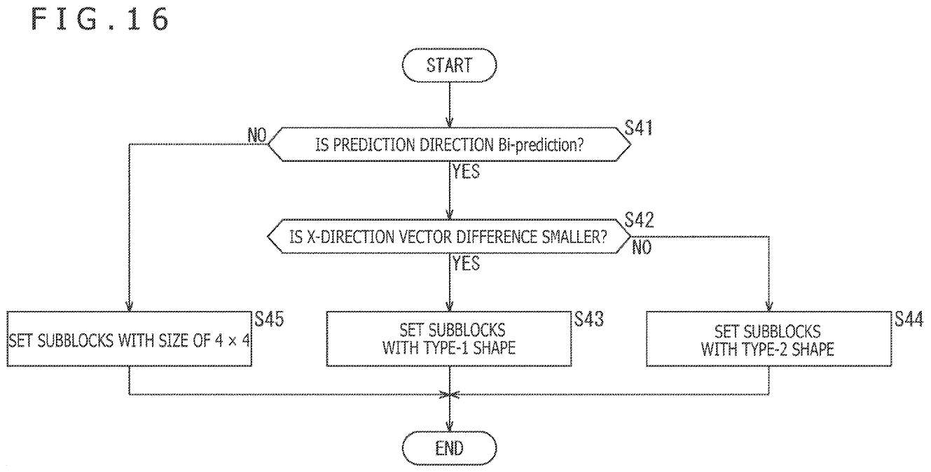

FIG. 16 is a flowchart for explaining a second processing example of the process of setting the subblock size identification information at Step S12 in FIG. 14.

At Step S41, the control section 101 determines whether or not the prediction direction in the inter-prediction process is Bi-prediction.

In a case that, at Step S41, the control section 101 determines the prediction direction in the inter-prediction process is Bi-prediction, the process proceeds to Step S42. Then, at Step S42 to S44, processes similar to the processes at Step S31 to S33 in FIG. 15 are performed, and the subblock size identification information is set on the basis of the magnitude relation of the Y-direction vector difference dv_{y} and the X-direction vector difference dvₓ.

On the other hand, in a case that, at Step S41, the control section 101 determines the prediction direction in the inter-prediction process is not Bi-prediction, the process proceeds to Step S45. At Step S45, the control section 101 sets the subblock size identification information such that subblocks with the size of 4×4 are used, and then the process ends.

As mentioned above, in a case that an inter-prediction process is performed as Bi-prediction which requires a larger processing amount, 4×8 subblocks or 8×4 subblocks larger than 4×4 subblocks can be used to thereby reduce the processing amount in the inter-prediction process. In addition, in a case that an inter-prediction process is performed not as Bi-prediction, but as Uni-prediction which requires a smaller processing amount, for example, smaller 4×4 subblocks can be used to thereby perform the inter-prediction process so as to attain higher image quality.

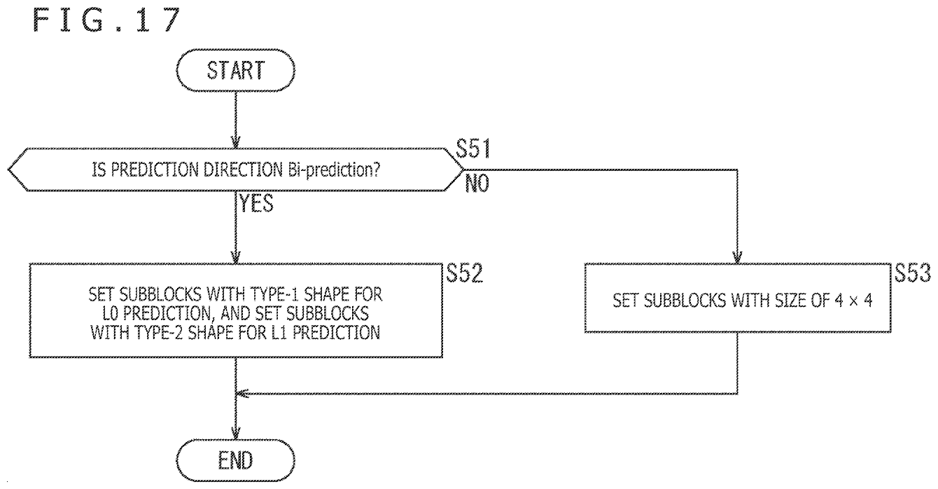

FIG. 17 is a flowchart for explaining a third processing example of the process of setting the subblock size identification information at Step S12 in FIG. 14.

At Step S51, the control section 101 determines whether or not the prediction direction in the inter-prediction process is Bi-prediction.

In a case that, at Step S51, the control section 101 determines the prediction direction in the inter-prediction process is Bi-prediction, the process proceeds to Step S52. At Step S52, the control section 101 sets subblocks with Type-1 shape for L0 prediction, and subblocks with Type-2 shape for L1 prediction as depicted in FIG. 9 mentioned above, and then the process ends.

On the other hand, in a case that, at Step S51, the control section 101 determines the prediction direction in the inter-prediction process is not Bi-prediction, the process proceeds to Step S53. At Step S53, the control section 101 sets the subblock size identification information such that subblocks with the size of 4×4 are used, and then the process ends.

As mentioned above, by using subblocks with Type-1 shape for L0 prediction, and subblocks with Type-2 shape for L1 prediction in Bi-prediction, image quality degradation can be suppressed as mentioned above with reference to FIG. 9.

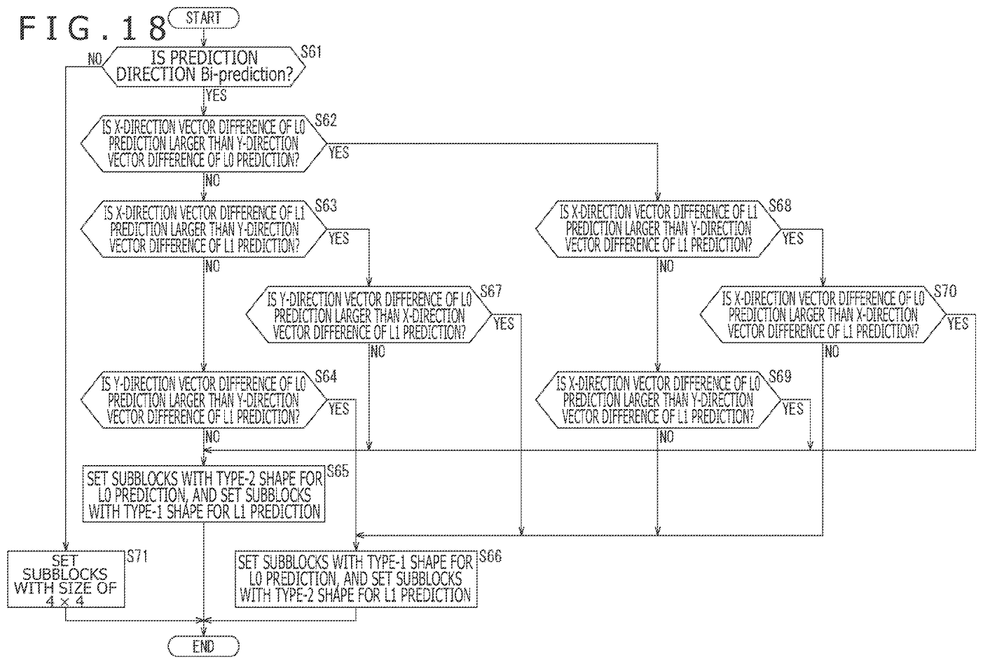

FIG. 18 is a flowchart for explaining a fourth processing example of the process of setting the subblock size identification information at Step S12 in FIG. 14.

At Step S61, the control section 101 determines whether or not the prediction direction in the inter-prediction process is Bi-prediction.

In a case that, at Step S61, the control section 101 determines the prediction direction in the inter-prediction process is Bi-prediction, the process proceeds to Step S62.

At Step S62, on the basis of results of calculations of Formula (2) mentioned above, the control section 101 determines whether or not the X-direction vector difference dv_{xL0} of L0 prediction is larger than the Y-direction vector difference dv_{yL0} of L0 prediction.

In a case that, at Step S62, the control section 101 determines that the X-direction vector difference dv_{xL0} of L0 prediction is not larger than the Y-direction vector difference dv_{yL0} of L0 prediction (the X-direction vector difference dv_{xL0} of L0 prediction is equal to or smaller than the Y-direction vector difference dv_{yL0} of L0 prediction), the process proceeds to Step S63.

At Step S63, on the basis of results of calculations of Formula (2) mentioned above, the control section 101 determines whether or not the X-direction vector difference dv_{xL1} of L1 prediction is larger than the Y-direction vector difference dv_{yL1} of L1 prediction.

In a case that, at Step S63, the control section 101 determines that the X-direction vector difference dv_{xL1} of L1 prediction is not larger than the Y-direction vector difference dv_{yL1} of L1 prediction (the X-direction vector difference dv_{XL1} of L1 prediction is equal to or smaller than the Y-direction vector difference dv_{yL1} of L1 prediction), the process proceeds to Step S64.

At Step S64, on the basis of results of calculations of Formula (2) mentioned above, the control section 101 determines whether or not the Y-direction vector difference dv_{yL0} of L0 prediction is larger than the Y-direction vector difference dv_{yL1} of L1 prediction.

In a case that, at Step S64, the control section 101 determines that the Y-direction vector difference dv_{yL0} of L0 prediction is not larger than the Y-direction vector difference dv_{yL1} of L1 prediction (the Y-direction vector difference dv_{yL0} of L0 prediction is equal to or smaller than the Y-direction vector difference dv_{yL1} of L1 prediction), the process proceeds to Step S65. That is, in this case, the Y-direction vector difference dv_{yL1} of L1 prediction is the largest.

At Step S65, the control section 101 sets subblocks with Type-2 shape for L0 prediction, and subblocks with Type-1 shape for L1 prediction as depicted in FIG. 10 mentioned above, and then the process ends.

On the other hand, in a case that, at Step S64, the control section 101 determines that the Y-direction vector difference dv_{yL0} of L0 prediction is larger than the Y-direction vector difference dv_{yL0} of L1 prediction, the process proceeds to Step S66. That is, in this case, the Y-direction vector difference dv_{yL0} of L0 prediction is the largest.

At Step S66, the control section 101 sets subblocks with Type-1 shape for L0 prediction, and subblocks with Type-1 shape for L1 prediction as depicted in FIG. 9 mentioned above, and then the process ends.

On the other hand, in a case that, at Step S63, the control section 101 determines that the X-direction vector difference dv_{xL1} of L1 prediction is larger than the Y-direction vector difference dv_{yL1} of L1 prediction, the process proceeds to Step S67.

At Step S67, on the basis of results of calculations of Formula (2) mentioned above, the control section 101 determines whether or not the Y-direction vector difference dv_{YL0} of L0 prediction is larger than the X-direction vector difference dv_{XL1} of L1 prediction.

In a case that, at Step S67, the control section 101 determines that the Y-direction vector difference dv_{YL0} of L0 prediction is not larger than the X-direction vector difference dv_{XL1} of L1 prediction (the Y-direction vector difference dv_{YL0} of L0 prediction is equal to or smaller than the X-direction vector difference dv_{XL1} of L1 prediction), the process proceeds to Step S65. That is, in this case, the X-direction vector difference dv_{XL1} of L1 prediction is the largest. Accordingly, at Step S65, subblocks with Type-2 shape are set for L0 prediction, and subblocks with Type-1 shape are set for L1 prediction as depicted in FIG. 9 mentioned above.

On the other hand, in a case that, at Step S67, the control section 101 determines that the Y-direction vector difference dv_{yL0} of L0 prediction is larger than the Y-direction vector difference dv_{yL1} of L1 prediction, the process proceeds to Step S66. That is, in this case, the Y-direction vector difference dv_{yL0} of L0 prediction is the largest. Accordingly, at Step S66, subblocks with Type-1 shape are set for L0 prediction, and subblocks with Type-1 shape are set for L1 prediction as depicted in FIG. 9 mentioned above.

At Step S68, on the basis of results of calculations of Formula (2) mentioned above, the control section 101 determines whether or not the X-direction vector difference dv_{XL1} of L1 prediction is larger than the Y-direction vector difference dv_{YL1} of L1 prediction.

In a case that, at Step S68, the control section 101 determines that the X-direction vector difference dv_{XL1} of L1 prediction is not larger than the Y-direction vector difference dv_{YL1} of L1 prediction (the X-direction vector difference dv_{XL1} of L1 prediction is equal to or smaller than the Y-direction vector difference dv_{YL1} of L1 prediction), the process proceeds to Step S69.

At Step S69, on the basis of results of calculations of Formula (2) mentioned above, the control section 101 determines whether or not the X-direction vector difference dv_{XL0} of L0 prediction is larger than the Y-direction vector difference dv_{YL1} of L1 prediction.

In a case that, at Step S69, the control section 101 determines that the X-direction vector difference dv_{XL0} of L0 prediction is not larger than the Y-direction vector difference dv_{YL1} of L1 prediction (the X-direction vector difference dv_{XL0} of L0 prediction is equal to or smaller than the Y-direction vector difference dv_{YL1} of L1 prediction), the process proceeds to Step S66. That is, in this case, the Y-direction vector difference dv_{YL1} of L1 prediction is the largest. Accordingly, at Step S66, subblocks with Type-1 shape are set for L0 prediction, and subblocks with Type-1 shape are set for L1 prediction as depicted in FIG. 9 mentioned above.

On the other hand, in a case that, at Step S69, the control section 101 determines that the X-direction vector difference dv_{XL0} of L0 prediction is larger than the Y-direction vector difference dv_{YL1} of L1 prediction, the process proceeds to Step S65. That is, in this case, the X-direction vector difference dv_{XL0} of L0 prediction is the largest. Accordingly, at Step S65, subblocks with Type-2 shape are set for L0 prediction, and subblocks with Type-1 shape are set for L1 prediction as depicted in FIG. 9 mentioned above.

On the other hand, in a case that, at Step S68, the control section 101 determines that the X-direction vector difference dv_{XL1} of L1 prediction is larger than the Y-direction vector difference dv_{YL1} of L1 prediction, the process proceeds to Step S70.

At Step S70, on the basis of results of calculations of Formula (2) mentioned above, the control section 101 determines whether or not the X-direction vector difference dv_{XL0} of L0 prediction is larger than the X-direction vector difference dv_{XL1} of L1 prediction.

In a case that, at Step S70, the control section 101 determines that the X-direction vector difference dv_{XL0} of L0 prediction is not larger than the X-direction vector difference dv_{XL1} of L1 prediction (the X-direction vector difference dv_{XL0} of L0 prediction is equal to or smaller than the X-direction vector difference dv_{XL1} of L1 prediction), the process proceeds to Step S66. That is, in this case, the X-direction vector difference dv_{XL1} of L1 prediction is the largest. Accordingly, at Step S66, subblocks with Type-1 shape are set for L0 prediction, and subblocks with Type-1 shape are set for L1 prediction as depicted in FIG. 9 mentioned above.

On the other hand, in a case that, at Step S70, the control section 101 determines that the X-direction vector difference dv_{XL0} of L0 prediction is larger than the X-direction vector difference dv_{XL1} of L1 prediction, the process proceeds to Step S65. That is, in this case, the X-direction vector difference dv_{XL0} of L0 prediction is the largest. Accordingly, at Step S65, subblocks with Type-2 shape are set for L0 prediction, and subblocks with Type-1 shape are set for L1 prediction as depicted in FIG. 9 mentioned above.

On the other hand, in a case that, at Step S61, the control section 101 determines the prediction direction in the inter-prediction process is not Bi-prediction, the process proceeds to Step S71. At Step S71, the control section 101 sets the subblock size identification information such that subblocks with the size of 4×4 are used, and then the process ends.

As mentioned above, on the basis of results of comparisons between the X-direction vector difference dv_{XL0} of L0 prediction, the Y-direction vector difference dv_{YL0} of L0 prediction, the X-direction vector difference dv_{XL1} of L1 prediction, and the Y-direction vector difference dv_{YL1} of L1 prediction, the subblock size identification information can be set such that the longitudinal direction of rectangular subblocks is switched between the X direction and the Y direction for L0 prediction and L1 prediction.

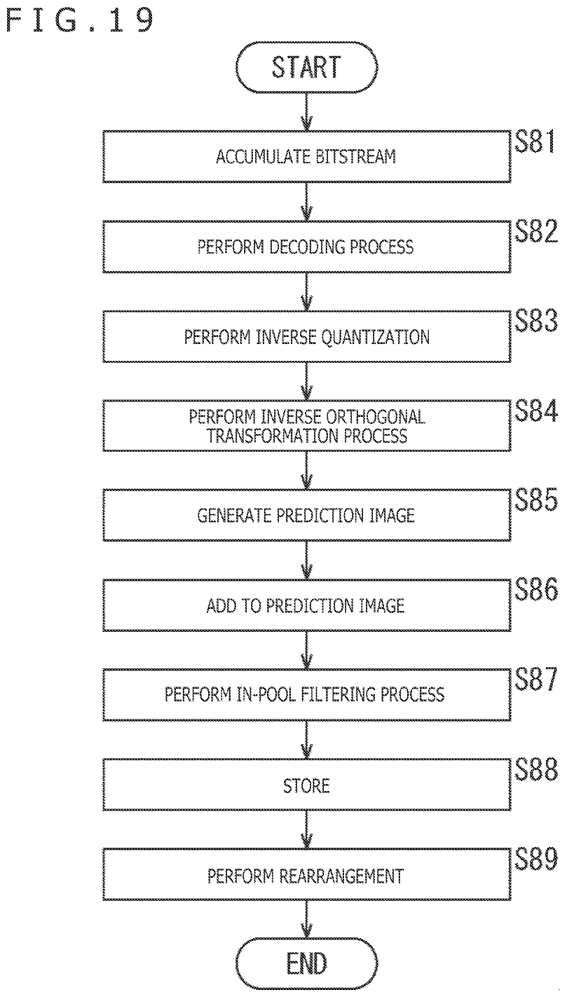

FIG. 19 is a flowchart for explaining the image decoding process executed by the image decoding apparatus 13.

When the image decoding process is started, at Step S81, the accumulation buffer 211 acquires and retains (accumulates) encoded data (bitstream) supplied from the outside of the image decoding apparatus 13.

At Step S82, the decoding section 212 decodes the encoded data (bitstream), and obtains the quantization transformation coefficient level level. In addition, by this decoding, the decoding section 212 parses the encoded data (bitstream) to obtain various types of encoding parameter (analyzes the encoded data to acquire the various types of encoding parameter). Here, when the decoding process is performed, a process of parsing the bitstream to obtain the subblock size identification information is also performed as mentioned above with reference to FIG. 3.

At Step S83, on the quantization transformation coefficient level level obtained by the process at Step S82, the inverse quantizing section 213 performs inverse quantization which is an inverse process of the quantization performed on the encoding side, and obtains the transformation coefficient Coeff_IQ.

At Step S84, on the transformation coefficient Coeff_IQ obtained by the process at Step S83, the inverse orthogonal transforming section 214 performs an inverse orthogonal transformation process which is an inverse process of the orthogonal transformation process performed on the encoding side, and obtains the prediction residue D′.

At Step S85, on the basis of the information obtained by the parsing at Step S82, the predicting section 219 executes a prediction process by a prediction method specified on the encoding side, and generates the prediction image P by referring to the reference image stored on the frame memory 218, and so on. Here, when the prediction process is performed, the size and the shape of subblocks used in the inter-prediction process can be switched in accordance with the subblock size identification information obtained by the parsing at Step S82 as mentioned above with reference to FIG. 3.

At Step S86, the calculating section 215 adds together the prediction residue D′ obtained by the process at Step S84, and the prediction image P obtained by the process at Step S85, and derives the locally-decoded image R_{local}.

At Step S87, the in-loop filter section 216 performs an in-loop filtering process on the locally-decoded image R_{local} obtained by the process at Step S86.

At Step S88, the rearranging buffer 217 derives the decoded image R by using the locally-decoded image R_{local} having been subjected to the filtering process obtained by the process at Step S87, and rearranges the decoded image R group arranged in a decoding order such that the decoded image R group is arranged in a reproduction order. The decoded image R group that is rearranged in the reproduction order is output to the outside of the image decoding apparatus 13 as a moving image.

In addition, at Step S89, the frame memory 218 stores at least one of the locally-decoded image R_{local} obtained by the process at Step S86, and the locally-decoded image R_{local} after having been subjected to the filtering process obtained by the process at Step S87.

When the process at Step S89 ends, the image decoding process ends.

In the image decoding process with a flow like the one above, processes to which the present technology mentioned above is applied are performed as the processes at Step S82 and Step S85. Accordingly, by executing this image decoding process to use larger subblocks or use subblocks with Type-1 shape or Type-2 shape, it is possible to reduce the processing amount in an inter-prediction process.

Note that the process about an interpolation filter like the one mentioned above may be applied also to an AIF (Adaptive Interpolation Filter), for example.

<Configuration Example of Computer>

Next, the series of processing mentioned above can also be performed by hardware, or can also be performed by software. In a case that the series of processing is performed by software, a program included in the software is installed on a general-purpose computer or the like.

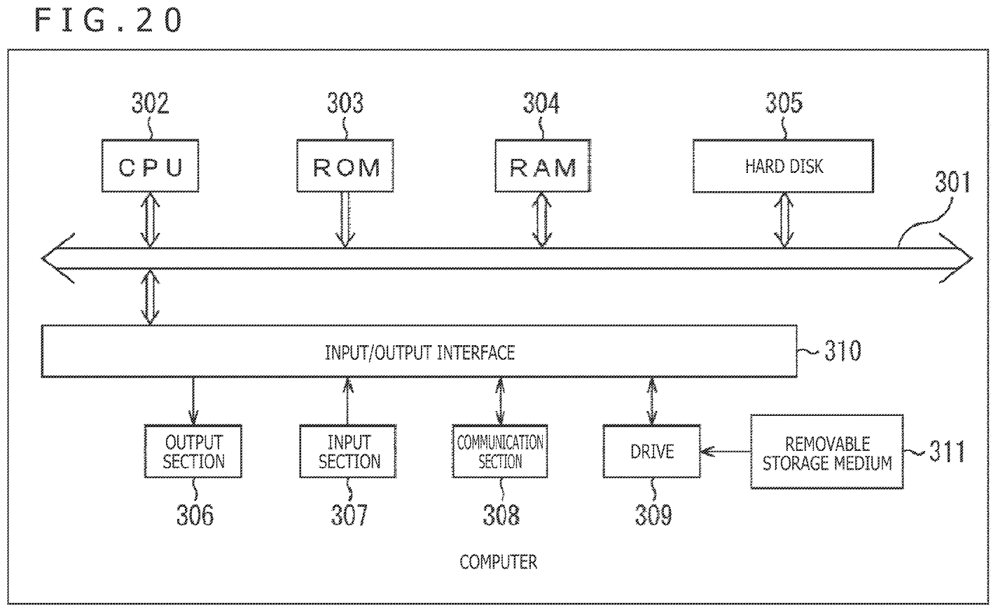

FIG. 20 is a block diagram depicting a configuration example of one embodiment of a computer on which the program that executes the series of processing mentioned above is installed.

The program can be recorded in advance on a hard disk 305 or a ROM 303 as a recording medium built in a computer.

Alternatively, the program can be stored (recorded) on a removable recording medium 311 driven by a drive 309. Such a removable recording medium 311 can be provided as generally-called package software. Here, examples of the removable recording medium 311 include, for example, a flexible disc, a CD-ROM (Compact Disc Read Only Memory), an MO (Magneto Optical) disc, a DVD (Digital Versatile Disc), a magnetic disc, a semiconductor memory, and the like.

Note that other than being installed on the computer from the removable recording medium 311 like the one mentioned above, the program can be downloaded onto the computer via a communication network or a broadcast network, and installed on the built-in hard disk 305. That is, for example, the program can be transferred from a download site wirelessly to the computer via an artificial satellite for digital satellite broadcasting, or transferred through cables to the computer via a network like a LAN (Local Area Network) or the Internet.

The computer has a built-in CPU (Central Processing Unit) 302, and the CPU 302 is connected with an input/output interface 310 via a bus 301.

Upon reception, as an input, of a command through operation of an input section 307 by a user, and so on, via the input/output interface 310, the CPU 302 executes the program stored on the ROM (Read Only Memory) 303 in accordance with the command. Alternatively, the CPU 302 executes the program stored on the hard disk 305 by loading it onto a RAM (Random Access Memory) 304.

Thereby, the CPU 302 performs processes according to flowcharts mentioned above, or processes performed by configurations in block diagrams mentioned above. Then, the CPU 302 causes results of the processes to be output from an output section 306, transmitted from a communication section 308, recorded on the hard disk 305, and so on, via the input/output interface 310, for example, as necessary.

Note that the input section 307 includes a keyboard, a mouse, a microphone, and the like. In addition, the output section 306 includes an LCD (Liquid Crystal Display), a speaker, and the like.

Here, in the present specification, processes performed by the computer in accordance with the program need not necessarily be performed in a temporal sequence along the orders described in the flowcharts. That is, processes performed by the computer in accordance with the program also include processes (e.g. parallel processes, or processes by objects) executed in parallel or individually.

In addition, the program may be one that is processed by a single computer (processor), or may be one that is processed in a distributed manner by a plurality of computers. Furthermore, the program may be one that is transferred to a remote computer, and executed thereon.

Furthermore, in the present specification, a system means a set of a plurality of constituent elements (apparatuses, modules (components), etc.), and it does not matter whether or not all the constituent elements are located in a single housing. Accordingly, a plurality of apparatuses housed in separate housings, and connected via a network, and one apparatus with one housing having housed therein a plurality of modules are both systems.

In addition, for example, a configuration explained as one apparatus (or processing section) may be divided, and configured as a plurality of apparatuses (or processing sections). On the other hand, configurations explained as a plurality of apparatuses (or processing sections) above may be integrated, and configured as one apparatus (or processing section). In addition, configurations other than those mentioned above may certainly be added to the configuration of each apparatus (or each processing section). Furthermore, as long as configurations and operations as the whole system are substantially the same, part of the configuration of an apparatus (or processing section) may be included in the configuration of another apparatus (or another processing section).

In addition, for example, the present technology can have a configuration of cloud computing in which one functionality is shared among a plurality of apparatuses via a network, and is processed in cooperation with each other.

In addition, for example, the program mentioned above can be executed in a certain apparatus. In that case, it is sufficient if the apparatus has necessary functionalities (functional blocks, etc.), and can obtain necessary information.

In addition, for example, other than being executed on one apparatus, each step explained in a flowchart mentioned above can be shared by a plurality of apparatuses, and executed thereon. Furthermore, in a case that one step includes a plurality of processes, other than being executed on one apparatus, the plurality of processes included in the one step can be shared among a plurality of apparatuses, and executed thereon. In other words, the plurality of processes included in the one step can also be executed as processes of a plurality of steps. On the other hand, processes explained as a plurality of steps can also be executed collectively as one step.

Note that regarding the program executed by the computer, processes of steps describing the program may be executed in a temporal sequence along an order explained in the present specification, may be executed in parallel, or may be executed individually at necessary timings such as timings when those processes are called. That is, as long as contradictions do not occur, a process of each step may be executed in an order different from an order mentioned above. Furthermore, processes of steps describing the program may be executed in parallel with processes of other programs, and may be executed in combination with processes of other programs.

Note that a plurality of aspects of the present technology that is explained in the present specification can each be implemented independently and singly as long as such implementation does not give rise to contradictions. Certainly, a certain plurality of aspects of the present technology can also be implemented in combination. For example, part or the whole of the present technology explained in any of the embodiments can also be implemented by being combined with part or the whole of the present technology explained in another embodiment. In addition, certain part or the whole of the present technology mentioned above can also be implemented by being combined with another technology not mentioned above.

<Application Targets of Present Technology>

The present technology can be applied to any image encoding and decode method. That is, specifications of various types of process related to image encoding and decoding such as transformation (inverse-transformation), quantization (inverse quantization), encoding (decoding) or prediction can be any specifications as long as those specifications do not contradict the present technology mentioned above, and are not limited to examples mentioned above. In addition, some of those processes may be omitted as long as such omissions do not give rise to contradictions with the present technology mentioned above.

In addition, the present technology can be applied to a multi-viewpoint image encoding and decoding system that performs encoding and decoding of multi-viewpoint images including images of a plurality of viewpoints (views). In that case, it is sufficient if the present technology is applied to encoding and decoding of each viewpoint (view).

Furthermore, the present technology can be applied to a hierarchical image encoding (scalable encoding) and decoding system that performs encoding and decoding of a hierarchical image having a plurality of layers (hierarchies) so as to have a scalability functionality for predetermined parameters. In that case, it is sufficient if the present technology is applied to encoding and decoding of each hierarchy (layer).

For example, the image encoding apparatus and the image decoding apparatus according to embodiments can be applied to various electronic equipment such as a transmitter or a receiver (e.g. a television receiver or a mobile phone) in satellite broadcasting, cable broadcasting such as cable TV, distribution on the Internet, distribution to terminals in cellular communication, or the like, or an apparatus (e.g. a hard disk recorder or a camera) that records images on a medium such as an optical disc, a magnetic disc or a flash memory, or reproduces the images from those storage media.

In addition, for example, the present technology can also be implemented as a certain apparatus or any configuration to be mounted on an apparatus included in a system, such as a processor (e.g. a video processor) as a system LSI (Large Scale Integration) or the like, a module (e.g. a video module) that uses a plurality of processors or the like, a unit (e.g. a video unit) that uses a plurality of modules or the like, a set (e.g. a video set) which is a unit having still other additional functionalities, or the like (i.e. the present technology can be implemented as a partial configuration of the apparatus).

Furthermore, the present technology can also be applied to a network system including a plurality of apparatuses. For example, the present technology can also be applied to a cloud service of providing a service related to images (moving images) to a certain terminal such as a computer, AV (Audio Visual) equipment, a mobile information processing terminal or an IoT (Internet of Things) device.

Note that systems, apparatuses, processing sections, and the like to which the present technology is applied can be used in any field such as, for example, transportation, medical care, crime prevention, agriculture, the livestock industry, the mining industry, the beauty industry, factories, home electric appliances, meteorology or nature monitoring. In addition, its use in those fields also can be any use.

For example, the present technology can be applied to systems and devices prepared for providing contents for appreciation, and the like. In addition, for example, the present technology can be applied also to systems and devices prepared for transportation such as supervision of traffic situations or automated driving control. Furthermore, for example, the present technology can be applied also to systems and devices prepared for security. In addition, for example, the present technology can be applied to systems and devices that are prepared for automatic control of machines and the like. Furthermore, for example, the present technology can be applied to systems and devices that are prepared for the agriculture and livestock industries. In addition, for example, the present technology can be applied also to systems and devices that monitor the states of nature, wildlife, and the like such as volcanos, forests, or oceans. Furthermore, for example, the present technology can be applied also to systems and devices prepared for sports.

<Combination Examples of Configurations>

Note that the present technology can have configurations like the ones mentioned below.

(1)

An image encoding apparatus including:

a setting section that sets identification information identifying a size or a shape of subblocks used for an inter-prediction process on an image, on the basis of a motion vector used for motion compensation in an affine transformation; and

an encoding section that encodes the image by performing the inter-prediction process of applying the affine transformation on the subblocks with the size or the shape according to the setting by the setting section, and generates a bitstream including the identification information.

(2)

The image encoding apparatus according to (1), in which, for the subblocks with a rectangular shape, the setting section performs the setting, while switching a longitudinal direction of the rectangular shape to an X direction and a Y direction.

(3)

The image encoding apparatus according to (1) or (2), in which, in a case that an X-direction vector difference is smaller than a Y-direction vector difference, the setting section sets the identification information such that a longitudinal direction of the subblocks with a rectangular shape coincides with an X direction.

(4)

The image encoding apparatus according to (3), in which, in a case that the X-direction vector difference is smaller than the Y-direction vector difference, the setting section sets the identification information such that a size of the subblocks with the rectangular shape is 8×4.

(5)

The image encoding apparatus according to any of (1) to (4), in which, in a case that a Y-direction vector difference is smaller than an X-direction vector difference, the setting section sets the identification information such that a longitudinal direction of the subblocks with a rectangular shape coincides with a Y direction.

(6)

The image encoding apparatus according to (5), in which, in a case that the Y-direction vector difference is smaller than the X-direction vector difference, the setting section sets the identification information such that a size of the subblocks with the rectangular shape is 4×8.

(7)

The image encoding apparatus according to any of (1) to (6), in which

the setting section
computes an X-direction vector difference and a Y-direction vector difference by using motion vectors of an upper left vertex, an upper right vertex, and a lower left vertex of the subblocks,
sets the identification information such that a longitudinal direction of the subblocks with a rectangular shape coincides with an X direction in a case that an absolute value of the X-direction vector difference is larger than an absolute value of the Y-direction vector difference, and
sets the identification information such that the longitudinal direction of the subblocks with the rectangular shape coincides with a Y direction in a case that the absolute value of the X-direction vector difference is equal to or smaller than the absolute value of the Y-direction vector difference.

(8)

The image encoding apparatus according to any of (1) to (7), in which the setting section sets the identification information such that the subblocks with a rectangular shape are used in a case that a prediction direction in the inter-prediction process is Bi-prediction.

(9)

The image encoding apparatus according to (8), in which the setting section sets the identification information such that a longitudinal direction of the subblocks with the rectangular shape used for either one of a forward prediction and a backward prediction in the inter-prediction process of Bi-prediction coincides with an X direction, and the longitudinal direction of the subblocks with the rectangular shape to be used for another of the forward prediction and the backward prediction coincides with a Y direction.

(10)

The image encoding apparatus according to (9), in which

the setting section
computes an X-direction vector difference of the forward prediction, and a Y-direction vector difference of the forward prediction by using motion vectors of an upper left vertex, an upper right vertex, and a lower left vertex of the subblocks used for the forward prediction,
computes an X-direction vector difference of the backward prediction, and a Y-direction vector difference of the backward prediction by using motion vectors of an upper left vertex, an upper right vertex, and a lower left vertex of the subblocks used for the backward prediction,
sets the identification information such that a longitudinal direction of the subblocks with the rectangular shape used for the forward prediction coincides with the Y direction, and the longitudinal direction of the subblocks with the rectangular shape used for the backward prediction coincides with the X direction in a case that the X-direction vector difference of the forward prediction, or the X-direction vector difference of the backward prediction is the largest, and
sets the identification information such that the longitudinal direction of the subblocks with the rectangular shape used for the forward prediction coincides with the X direction, and the longitudinal direction of the subblocks with the rectangular shape used for the backward prediction coincides with the Y direction in a case that the Y-direction vector difference of the forward prediction, or the Y-direction vector difference of the backward prediction is the largest.

(11)

An image encoding method including:

setting, by an image encoding apparatus that encodes an image, identification information identifying a size or a shape of subblocks used for an inter-prediction process on the image, on the basis of a motion vector used for motion compensation in an affine transformation; and

encoding, by the image encoding apparatus, the image by performing the inter-prediction process of applying the affine transformation on the subblocks with the size or the shape according to the setting, and generating a bitstream including the identification information.

(12)

An image decoding apparatus including:

a parsing section that parses a bitstream including identification information to obtain the identification information, the identification information being set on the basis of a motion vector used for motion compensation in an affine transformation, and identifying a size or a shape of subblocks used for an inter-prediction process on an image; and

a decoding section that decodes the bitstream by performing the inter-prediction process of applying the affine transformation on the subblocks with the size or the shape according to the identification information obtained by the parsing by the parsing section, and generates the image.

(13)

An image decoding method including:

parsing, by an image decoding apparatus that decodes an image, a bitstream including identification information to obtain the identification information, the identification information being set on the basis of a motion vector used for motion compensation in an affine transformation, and identifying a size or a shape of subblocks used for an inter-prediction process on the image; and

decoding, by the image decoding apparatus, the bitstream by performing the inter-prediction process of applying an affine transformation on the subblocks with the size or the shape according to the identification information obtained by the parsing, and generating the image.

Note that the present embodiment is not limited to the embodiments mentioned above but can be modified in various manners within the scope not deviating from the gist of the present disclosure. In addition, advantages described in the present specification are described not for limitation, but merely for illustrative purposes, and there may be other advantages.

### REFERENCE SIGNS LIST

11: Image processing system
12: Image encoding apparatus
13: Image decoding apparatus
21: Image processing chip
22: External memory
23: Encoding circuit
24: Cache memory
31: Image processing chip
32: External memory
33: Decoding circuit
34: Cache memory
35: Horizontal interpolation filter
36: Transpose memory
37: Vertical interpolation filter
38: Averaging section
101: Control section
122: Predicting section
113: Orthogonal transforming section
115: Encoding section
118: Inverse orthogonal transforming section
120: In-loop filter section
212: Decoding section
214: Inverse orthogonal transforming section
216: In-loop filter section
219: Predicting section

1. An image encoding apparatus comprising:
a setting section that sets identification information identifying a size or a shape of subblocks used for an inter-prediction process on an image, on a basis of a motion vector used for motion compensation in an affine transformation; and
an encoding section that encodes the image by performing the inter-prediction process of applying the affine transformation on the subblocks with the size or the shape according to the setting by the setting section, and generates a bitstream including the identification information.

2. The image encoding apparatus according to claim 1, wherein, for the subblocks with a rectangular shape, the setting section performs the setting, while switching a longitudinal direction of the rectangular shape to an X direction and a Y direction.

3. The image encoding apparatus according to claim 1, wherein, in a case that an X-direction vector difference is smaller than a Y-direction vector difference, the setting section sets the identification information such that a longitudinal direction of the subblocks with a rectangular shape coincides with an X direction.

4. The image encoding apparatus according to claim 3, wherein, in a case that the X-direction vector difference is smaller than the Y-direction vector difference, the setting section sets the identification information such that a size of the subblocks with the rectangular shape is 8×4.

5. The image encoding apparatus according to claim 1, wherein, in a case that a Y-direction vector difference is smaller than an X-direction vector difference, the setting section sets the identification information such that a longitudinal direction of the subblocks with a rectangular shape coincides with a Y direction.

6. The image encoding apparatus according to claim 5, wherein, in a case that the Y-direction vector difference is smaller than the X-direction vector difference, the setting section sets the identification information such that a size of the subblocks with the rectangular shape is 4×8.

7. The image encoding apparatus according to claim 1, wherein
the setting section
computes an X-direction vector difference and a Y-direction vector difference by using motion vectors of an upper left vertex, an upper right vertex, and a lower left vertex of the subblocks,
sets the identification information such that a longitudinal direction of the subblocks with a rectangular shape coincides with an X direction in a case that an absolute value of the X-direction vector difference is larger than an absolute value of the Y-direction vector difference, and
sets the identification information such that the longitudinal direction of the subblocks with the rectangular shape coincides with a Y direction in a case that the absolute value of the X-direction vector difference is equal to or smaller than the absolute value of the Y-direction vector difference.

8. The image encoding apparatus according to claim 1, wherein the setting section sets the identification information such that the subblocks with a rectangular shape are used in a case that a prediction direction in the inter-prediction process is Bi-prediction.

9. The image encoding apparatus according to claim 8, wherein the setting section sets the identification information such that a longitudinal direction of the subblocks with the rectangular shape used for either one of a forward prediction and a backward prediction in the inter-prediction process of Bi-prediction coincides with an X direction, and the longitudinal direction of the subblocks with the rectangular shape to be used for another of the forward prediction and the backward prediction coincides with a Y direction.

10. The image encoding apparatus according to claim 9, wherein
the setting section
computes an X-direction vector difference of the forward prediction, and a Y-direction vector difference of the forward prediction by using motion vectors of an upper left vertex, an upper right vertex, and a lower left vertex of the subblocks used for the forward prediction,
computes an X-direction vector difference of the backward prediction, and a Y-direction vector difference of the backward prediction by using motion vectors of an upper left vertex, an upper right vertex, and a lower left vertex of the subblocks used for the backward prediction,
sets the identification information such that a longitudinal direction of the subblocks with the rectangular shape used for the forward prediction coincides with the Y direction, and the longitudinal direction of the subblocks with the rectangular shape used for the backward prediction coincides with the X direction in a case that the X-direction vector difference of the forward prediction, or the X-direction vector difference of the backward prediction is the largest, and
sets the identification information such that the longitudinal direction of the subblocks with the rectangular shape used for the forward prediction coincides with the X direction, and the longitudinal direction of the subblocks with the rectangular shape used for the backward prediction coincides with the Y direction in a case that the Y-direction vector difference of the forward prediction, or the Y-direction vector difference of the backward prediction is the largest.

11. An image encoding method comprising:
setting, by an image encoding apparatus that encodes an image, identification information identifying a size or a shape of subblocks used for an inter-prediction process on the image, on a basis of a motion vector used for motion compensation in an affine transformation; and
encoding, by the image encoding apparatus, the image by performing the inter-prediction process of applying the affine transformation on the subblocks with the size or the shape according to the setting, and generating a bitstream including the identification information.

12. An image decoding apparatus comprising:
a parsing section that parses a bitstream including identification information to obtain the identification information, the identification information being set on a basis of a motion vector used for motion compensation in an affine transformation, and identifying a size or a shape of subblocks used for an inter-prediction process on an image; and
a decoding section that decodes the bitstream by performing the inter-prediction process of applying the affine transformation on the subblocks with the size or the shape according to the identification information obtained by the parsing by the parsing section, and generates the image.

13. An image decoding method comprising:
parsing, by an image decoding apparatus that decodes an image, a bitstream including identification information to obtain the identification information, the identification information being set on a basis of a motion vector used for motion compensation in an affine transformation, and identifying a size or a shape of subblocks used for an inter-prediction process on the image; and
decoding, by the image decoding apparatus, the bitstream by performing the inter-prediction process of applying an affine transformation on the subblocks with the size or the shape according to the identification information obtained by the parsing, and generating the image.
